(19) United States
(12) Patent Application Publication
(10) Pub. No.: US 2015/0116388 A1
(43) Pub. Date: Apr. 30, 2015

(54) DISPLAY APPARATUS AND CONTROL METHOD THEREOF

(71) Applicant: CANON KABUSHIKI KAISHA, Tokyo (JP)

(72) Inventors: Tomoya Asanuma, Kawasaki-shi (JP); Shinya Oda, Kawasaki-shi (JP)

(21) Appl. No.: 14/524,428

(22) Filed: Oct. 27, 2014

(30) Foreign Application Priority Data
Oct. 31, 2013 (JP) 2013-226982
Jan. 6, 2014 (JP) 2014-000189

(51) Int. Cl. G09G 3/32

(52) U.S. Cl. CPC G09G 3/32; G09G 2320/0242; G09G 2320/0686
USPC 345/694

(57) ABSTRACT

A display apparatus according to the present invention includes a light-emitting unit; and a displaying unit configured to display an image on a screen by modulating light from the light-emitting unit, wherein, when a first image and a second image used to measure a visual characteristic of a user are displayed on the screen, the light-emitting unit emits first light in a display region that includes a region in which the first image is displayed, and emits second light having a broader emission spectrum distribution than the first light in a display region that includes a region in which the second image is displayed.

### BACKGROUND OF THE INVENTION

1. Field of the Invention

The present invention relates to a display apparatus and a control method thereof.

2. Description of the Related Art

It is known that colors (perceived colors) perceived by humans are determined from a spectral characteristic of an observation subject and a color-matching function. The spectral characteristic is an index expressing the colors of an object quantitatively, and is represented by an emission spectrum of a monitor (a display apparatus), a reflectance spectrum of a printed material, and so on. A perceived color is expressed by XYZ stimulus values, where X is a stimulus value relating to a red color sensation of an eye, Y is a stimulus value relating to a green color sensation of the eye, and Z is a stimulus value relating to a blue color sensation of the eye.

FIG. 1 shows a mechanism for determining a perceived color from a color matching function and the spectral characteristic of an observation subject. A reference numeral 101 denotes a spectral characteristic (a characteristic of an emission spectrum distribution) of a monitor displaying white, and a reference numeral 102 denotes a color-matching function. By multiplying a value of a color matching function 102X for determining the X stimulus value by a value of the spectral characteristic at each wavelength, a total value of multiplication results obtained at the respective wavelengths can be calculated as the X stimulus value. The Y stimulus value and the Z stimulus value can be calculated similarly using a color matching function 102Y for determining the Y stimulus value and a color matching function 102Z for determining the Z stimulus value, respectively. A surface area of a part (a part shaded gray) indicated by a reference numeral 103 is the X stimulus value expressing the red color component. Similarly, a surface area of a part indicated by a reference numeral 104 is the Y stimulus value expressing the green color component, and a surface area of a part indicated by a reference numeral 105 is the Z stimulus value expressing the blue color component. As shown in FIG. 1, an integration value of the value obtained by multiplying the value of the color matching function by the value of the spectral characteristic of the observation subject is calculated as the XYZ stimulus values expressing a perceived color.

However, color matching functions differ depending on the observer, and therefore a perceived color differs from observer to observer even when the spectral characteristic of the observation subject is unvarying from observer to observer. An amount of deviation in a perceived color from observer to observer depends on the spectral characteristic of the observation subject. For example, the amount of deviation in the perceived color from observer to observer is likely to be larger under light having a spectral characteristic with a narrow emission spectrum distribution than under light having a spectral characteristic with a broad emission spectrum distribution. More specifically, the amount of deviation is more likely to be large under light having a peak at a specific wave length, such as light from a light emitting diode (LED), than under light that includes light of many wavelengths, such as sunlight or light from a fluorescent lamp (e.g. a D50 fluorescent lamp having a high color-rendering property).

Hence, a method of measuring a visual characteristic (an individual visual characteristic) expressing the color perception of an individual observer has been investigated. A conventional example of a method of measuring an individual visual characteristic will now be described using FIG. 2.

A reference numeral 201 denotes a fluorescent lamp having a high color rendering property, which emits light onto a reference patch 204 printed onto a printed sheet 203. The light emitted from the fluorescent lamp 201 is light having a high color-rendering property, and therefore reflection light reflected by the reference patch 204 after being emitted from the fluorescent lamp 201 is likewise light having a high color-rendering property. Hence, little variation occurs in the perceived color of the reference patch 204 due to variation in a person or a field of vision, and therefore the reference patch 204 can be used as a reference for measuring an individual visual characteristic. A plurality of measurement patches 205 having different image data values are displayed on a monitor 202. An observer 207 uses an input device 206 to select a measurement patch perceived to be closest to the reference patch 204 from the plurality of measurement patches 205 displayed on the monitor 202. As a result, a value of the image data that are perceived to be closest in color to the color of the reference patch is specified. Difference data expressing a difference between a value of image data corresponding to the reference patch and the value of the image data of the measurement patch selected by the user are then obtained as visual characteristic information pertaining to the observer 207.

By performing the processing described above in relation to a plurality of reference patches of different colors, respective visual characteristic information pertaining to a plurality of colors can be obtained.

Further, by calculating difference data in relation to colors other than the colors of the reference patches used in the measurement on the basis of the visual characteristic information relating to the plurality of colors, visual characteristic information pertaining to all of the colors that can be displayed by the monitor can be obtained.

The color matching function of the observer 207 can then be calculated on the basis of the plurality of visual characteristic information pertaining to the plurality of colors.

Japanese Patent Application Publication No. H08-292735 discloses a technique of aligning a color displayed on a monitor with a printed material simply by performing a color-matching experiment with respect to luminosity in an arbitrary observation environment. In the technique disclosed in Japanese Patent Application Publication No. H08-292735, a user compares a printed material under a specific light source with a color on a monitor, and adjusts a parameter so that the color on the monitor matches the printed material. The parameter adjusted by the user is then reflected in the luminosity of the monitor, whereupon the luminosity reflecting the parameter is converted into a brightness of the monitor. XYZ values are then converted on the basis of the converted brightness.

### SUMMARY OF THE INVENTION

Conventionally, monitors are used and printed materials are observed under artificial light such as D50 fluorescent lamps that emit light having a high color-rendering property and producing little variation in a perceived color from observer to observer. Printed materials can thus be used as a reference for measuring an individual visual characteristic. It is believed, however, that in the future, artificial lighting that emits light having a different spectral characteristic from a fluorescent lamp, such as LED lighting, will be used in locations in which monitors are used and that printed materials, which are compared with images displayed on the monitors, will of course also be observed under this type of artificial lighting.

As described above, a perceived color is determined from the spectral characteristic of the observation subject and the color matching function, which is dependent on the individual. Moreover, the amount of deviation in the perceived color from observer to observer is dependent on the spectral characteristic of the observation subject. Depending on the type of used lighting, therefore, deviations in the perceived color of a printed material may occur among observers, making it impossible to measure individual visual characteristics with a high degree of precision.

FIG. 3 shows a mechanism by which a perceived color of a printed material differs from observer to observer due to a difference in environmental light illuminating the printed material.

In FIG. 3, a reference numeral 301 denotes the color matching function of an observer A, and a reference numeral 302 denotes the color matching function of an observer B. The color matching function is a function expressing the sensitivity of a human eye to wavelength. For the sake of simplicity, FIG. 3 shows only the color matching function relating to the Z stimulus value. A reference numeral 303 denotes the spectral characteristic of a printed material under LED lighting (reflected light emitted from the LED lighting and reflected by the printed material). A reference numeral 304 denotes the spectral characteristic of the printed material under a fluorescent lamp. The spectral characteristic of the printed material under the fluorescent lamp has a waveform with a broader emission spectrum distribution than the spectral characteristic of the printed material under the LED lighting. In other words, the spectral characteristic of the printed material under the fluorescent lamp has a high intensity over a broad wavelength band than the spectral characteristic of the printed material under the LED lighting.

A surface area of a shaded portion indicated by a reference numeral 307 represents the perceived color of the observer A in relation to the printed material under the fluorescent lamp, and a surface area of a shaded portion indicated by a reference numeral 308 represents the perceived color of the observer B in relation to the printed material under the fluorescent lamp. The spectral characteristic of the printed material under the fluorescent lamp has a high intensity over a broad wavelength band, and therefore, as shown by the reference numerals 307 and 308, a large deviation in the perceived color does not occur between the observers even when the shapes of the color matching functions of the respective observers differ from each other.

A surface area of a shaded portion indicated by a reference numeral 305 represents the perceived color of the observer A in relation to the printed material under the LED lighting, and a surface area of a shaded portion indicated by a reference numeral 306 represents the perceived color of the observer B in relation to the printed material under the LED lighting. In the spectral characteristic of the printed material under the LED lighting, the intensity is concentrated in a partial wavelength band, and therefore, as shown by the reference numerals 305 and 306, a large deviation in the perceived color occurs between the observers when the shapes of the color matching functions of the respective observers differ from each other.

Hence, depending on the type of used lighting, deviations in the perceived color of a printed material may occur among observers, making it impossible to measure individual visual characteristics with a high degree of precision. In other words, it may be impossible to use a printed material as a reference for measuring an individual visual characteristic.

The present invention provides a technique with which an individual visual characteristic can be measured with a high degree of precision.

The present invention in its first aspect provides

a display apparatus comprising:

a light emitting unit; and

a displaying unit configured to display an image on a screen by modulating light from the light emitting unit,

wherein, when a first image and a second image used to measure a visual characteristic of a user are displayed on the screen, the light emitting unit is configured to emit first light in a display region that includes a region in which the first image is displayed, and to emit second light having a broader emission spectrum distribution than the first light in a display region that includes a region in which the second image is displayed.

The present invention in its second aspect provides

a control method for a display apparatus having a light emitting unit and a displaying unit configured to display an image on a screen by modulating light from the light emitting unit, the control method comprising:

performing control for displaying a first image and a second image used to measure a visual characteristic of a user on the screen; and

controlling light emission by the light emitting unit such that when the first image and the second image are displayed on the screen, first light is emitted in a display region that includes a region in which the first image is displayed, and second light having a broader emission spectrum distribution than the first light is emitted in a display region that includes a region in which the second image is displayed.

It is desirable that an individual visual characteristic can be measured with a high degree of precision.

Further features of the present invention will become apparent from the following de script ion of exemplary embodiments with reference to the attached drawings.

### BRIEF DESCRIPTION OF THE DRAWINGS

FIG. 1 shows a mechanism for determining a perceived color from a color-matching function and a spectral characteristic;

FIG. 2 shows a conventional method of measuring an individual visual characteristic;

FIG. 3 shows a mechanism by which a deviation in a perceived color occurs due to a difference in environmental light;

FIG. 4 shows a method of measuring an individual visual characteristic according to a first embodiment;

FIG. 5 is a block diagram showing a configuration of a display apparatus according to the first embodiment;

FIG. 6 shows a configuration of a backlight unit according to the first embodiment;

FIG. 7 is a flowchart showing an operation of the display apparatus according to the first embodiment;

FIG. 8 illustrates light emission switch processing according to the first embodiment;

FIG. 9 is a flowchart showing the light emission switch processing according to the first embodiment;

FIG. 10 is also a flowchart showing the light emission switch processing according to the first embodiment;

FIG. 11 shows effects of the first embodiment;

FIG. 12 is a block diagram showing a configuration of a display apparatus according to a second embodiment;

FIG. 13 shows a configuration of a backlight unit according to the second embodiment;

FIG. 14 shows a spectral characteristic of a light-emitting element according to the second embodiment;

FIG. 15 shows light-emission switch processing according to the second embodiment;

FIG. 16 shows a configuration of a backlight unit according to a third embodiment;

FIG. 17 shows a spectral characteristic of a light-emitting element according to the third embodiment;

FIG. 18 is a block diagram showing a configuration of a display apparatus according to a fourth embodiment;

FIG. 19 shows a configuration of a backlight unit according to the fourth embodiment;

FIG. 20 shows light-emission switch processing according to the fourth embodiment;

FIG. 21 shows a configuration of a backlight unit according to a fifth embodiment;

FIG. 22 shows a method of measuring an individual visual characteristic according to a sixth embodiment;

FIG. 23 is a block diagram showing configurations of a display apparatus and a display control apparatus according to the sixth embodiment;

FIG. 24 is a block diagram showing configurations of a display apparatus and a display control apparatus according to a seventh embodiment;

FIGS. 25A and 25B show a general configuration of a system according to the seventh embodiment;

FIG. 26 is a front view showing a structure of a backlight unit according to the seventh embodiment;

FIG. 27 is a flowchart showing a flow of processing performed in the system according to the seventh embodiment;

FIGS. 28A to 28D show display images according to the seventh embodiment;

FIGS. 29A and 29B show spectral characteristics according to the seventh embodiment;

FIG. 30 is a block diagram showing examples of configurations of a display control apparatus and a display apparatus according to an eighth embodiment;

FIG. 31 is a flowchart showing a flow of processing performed in a system according to the eighth embodiment; and

FIGS. 32A and 32B show a method of determining a color of a reference image according to the eighth embodiment.

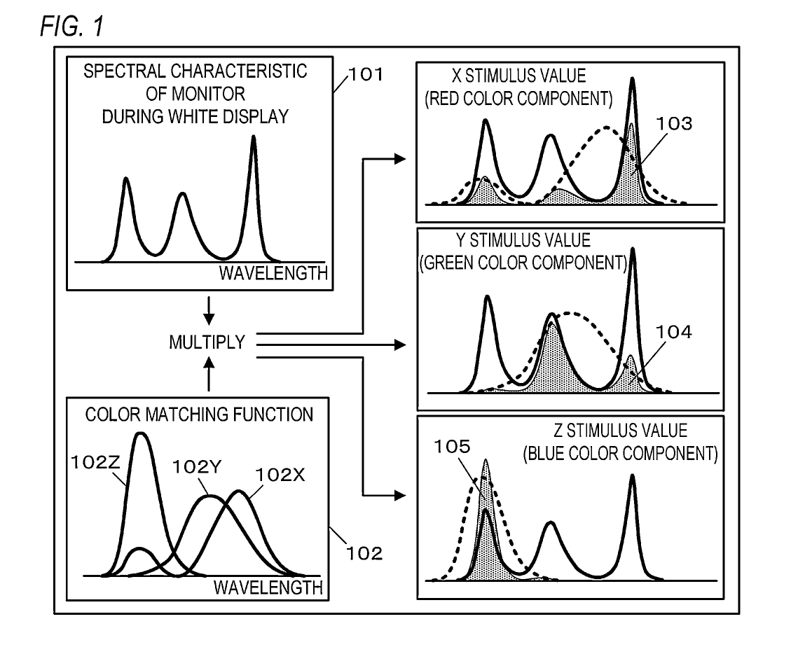

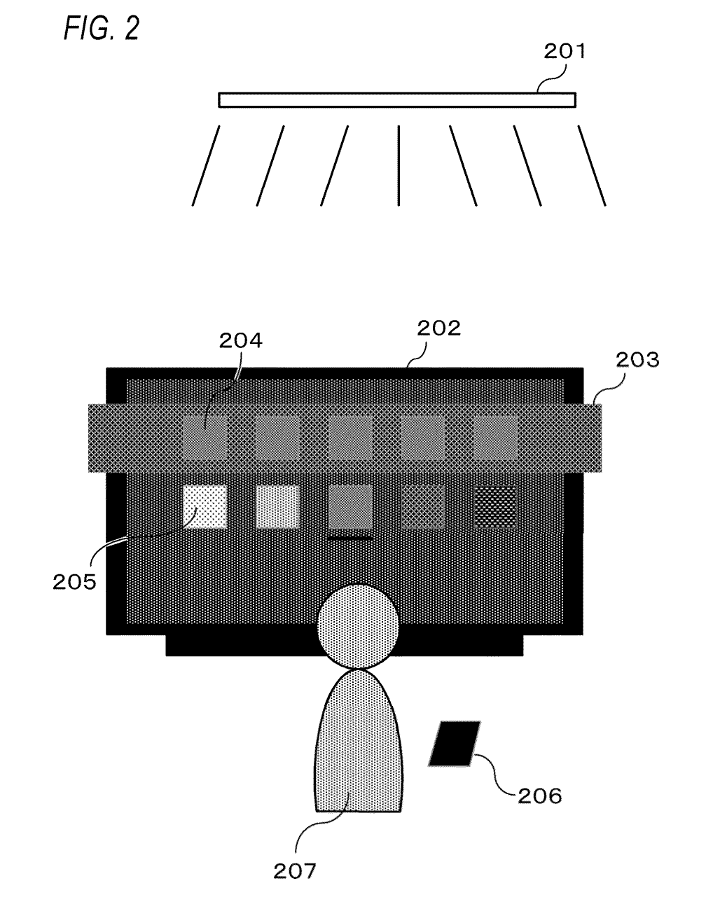

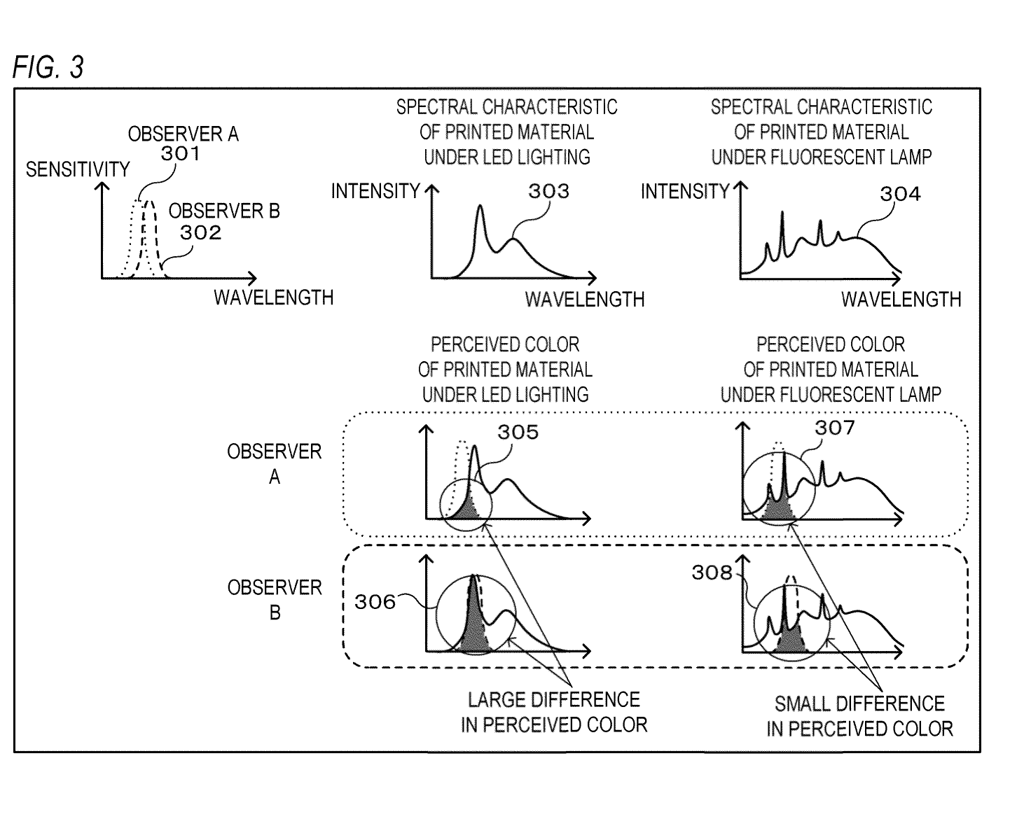

### DESCRIPTION OF THE EMBODIMENTS

### First Embodiment

A display apparatus and a control method thereof according to a first embodiment of the present invention will now be described. In the first embodiment, an example will be described in which a measurement patch (also referred to as a first image) and a reference patch (also referred to as a second image) are displayed and a visual characteristic (i.e. an individual visual characteristic) of a user is measured by having the user compare the reference patch with the measurement patch.

Note that in this embodiment, an example in which the first image and the second image are patch images will be described, but the first image and the second image do not have to be patch images. For example, the first image and the second image may be predetermined graphic images such as icons.

The display apparatus according to this embodiment includes a light-emitting unit and a display unit that displays an image on a screen by modulating light from the light-emitting unit.

During normal image display, the light-emitting unit emits first light over an entire region of the screen. More specifically, the light-emitting unit includes a first light source, and emits the first light by driving the first light source during normal image display. In this embodiment, the first light source includes a plurality of colored LEDs that respectively emit differently colored light as light-emitting elements. In this embodiment, the plurality of colored LEDs provided in the first light source include red LEDs (R-LEDs) that emit red light, green LEDs (G-LEDs) that emit green light, and blue LEDs (B-LEDs) that emit blue light. By performing image display by driving LEDs, a power consumption of the light emitting unit can be reduced. Further, by performing image display by driving colored LEDs, a color gamut of a displayed image (an image displayed on the screen) can be increased.

Further, when the first image and the second image are displayed on the screen, the light-emitting unit emits the first light in a display region that includes a region in which the first image is displayed, and emits second light having a broader emission spectrum distribution than the first light in a display region that includes a region in which the second image is displayed. More specifically, the light-emitting unit includes a second light source, and emits the second light by driving the second light source. In this embodiment, the second light source can be a cold cathode tube element (also known as a CCFL: cold cathode fluorescent lamp) as a light-emitting element. By performing image display by driving a cold cathode tube element, an image that produces little deviation in the perceived color from user to user can be displayed as the second image, and therefore the second image can be used as a reference for measuring an individual visual characteristic.

Note that in this embodiment, an example in which the first light is emitted by driving the R-LEDs, G-LEDs, and B-LEDs and the second light is emitted by driving the cold cathode tube element is described, but the first light and the second light are not limited thereto. As long as light having a broader emission spectrum distribution than the first light is obtained as the second light, the first light and the second light may be realized using any desired light sources and light-emitting elements.

This embodiment will now be described in further detail using the drawings.

An example in which the display apparatus according to this embodiment is a transmissive liquid crystal display apparatus will be described below, but the display apparatus according to this embodiment is not limited thereto. The display apparatus according to this embodiment may be any display apparatus that displays an image on a screen by modulating light emitted from a light emitting unit. For example, the display apparatus according to this embodiment may be a reflective liquid crystal display apparatus. Further, the display apparatus according to this embodiment may be a MEMS (Micro Electro Mechanical System) shutter type display that uses a MEMS shutter instead of a liquid crystal element.

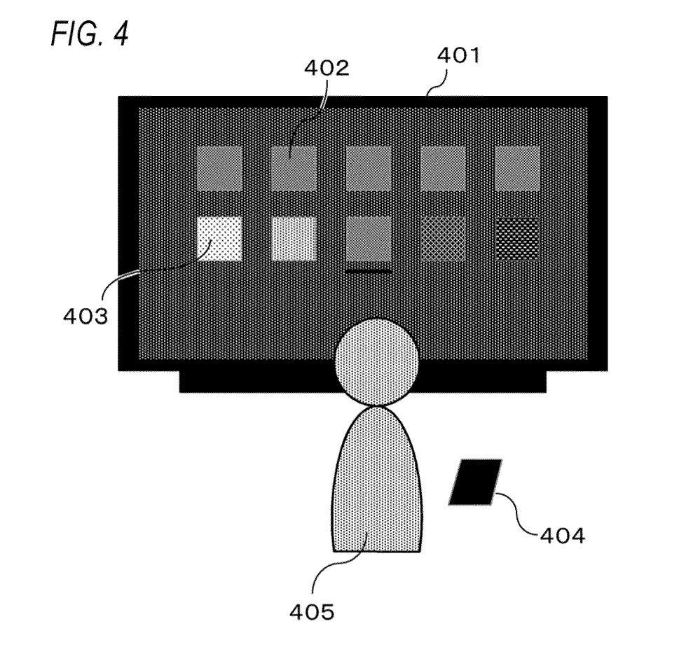

A method of measuring an individual visual characteristic using the display apparatus according to this embodiment will now be described broadly using FIG. 4.

A reference numeral 401 denotes the display apparatus (a monitor) according to this embodiment. When an individual visual characteristic is to be measured, the monitor 401 displays a reference patch 402 (the second image) and a measurement patch 403 (the first image).

A reference numeral 405 is an individual visual characteristic measurement subject who is a user. The user 405 compares the reference patch 402 and the measurement patch 403 displayed on the monitor 401. In the example of FIG. 4, five measurement patches 403 in different colors are displayed, and the user 405 selects the patch image perceived to be closest to the reference patch 402 from the five measurement patches 403. The patch image is selected by the user 405 by operating an input device 404 such as a remote controller, for example. The monitor calculates the individual visual characteristic on the basis of the selection result by the user.

Although five measurement patches 403 are displayed in the example shown in FIG. 4, the number of measurement patches 403 may be higher or lower than five. For example, three measurement patches may be displayed such that one of the three measurement patches is selected, or ten measurement patches may be displayed such that one of the ten measurement patches is selected.

Note that in the example shown in FIG. 4, to facilitate the comparison, five identically colored reference patches 402 are displayed in association with the five differently colored measurement patches. However, a single patch image may be displayed alone as the reference patch 402.

The individual visual characteristic measurement method is not limited to the method described above. For example, the user may adjust the color of the second image to match the color of the first image, whereupon the individual visual characteristic may be calculated on the basis of the adjustment result.

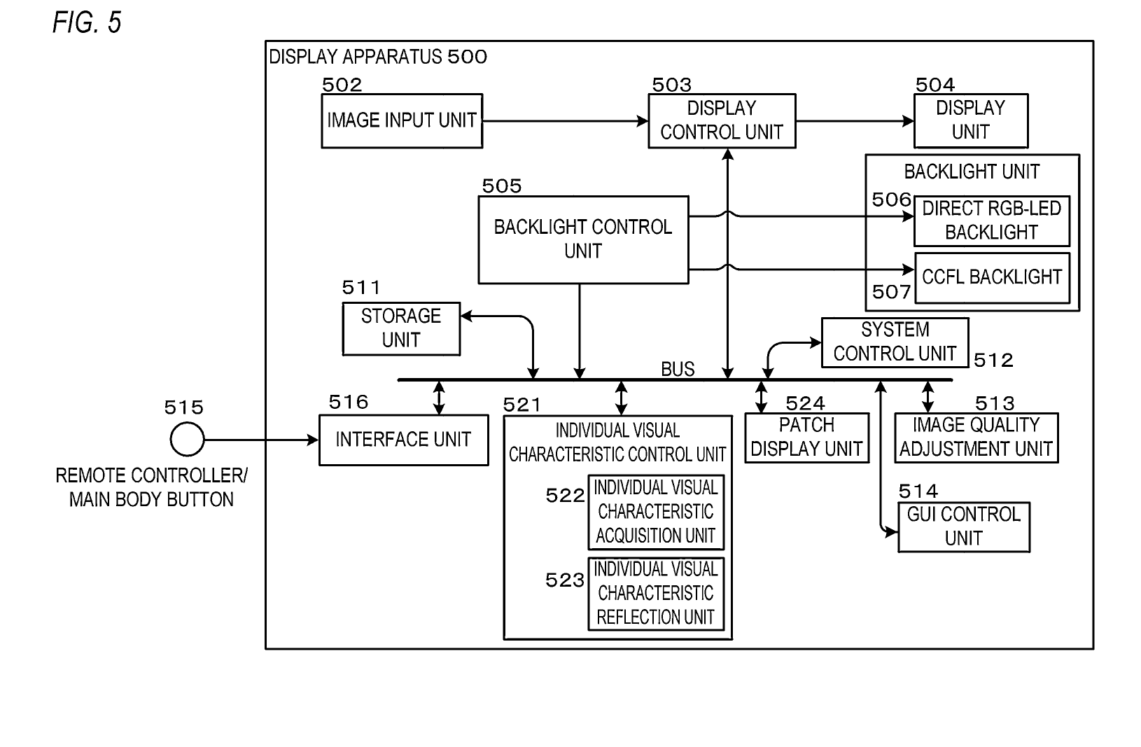

A configuration of the display apparatus according to this embodiment will now be described using FIG. 5. FIG. 5 is a block diagram showing an example of the configuration of a display apparatus 500 according to this embodiment.

An image input unit 502 obtains image data output from an external apparatus (an image generating apparatus) as normal image data. Note that the image input unit 502 may obtain the normal image data from a recording medium (a storage unit 511, for example) provided in the interior of the display apparatus 500.

The image input unit 502 outputs the obtained normal image data to a display control unit 503.

The display control unit 503 obtains the normal image data output from the image input unit 502, and generates display image data to be output to a display unit 504.

If necessary, the display control unit 503 outputs the normal image data to an image quality adjustment unit 513 to cause the image quality adjustment unit 513 to perform image quality adjustment processing on the normal image data. Here, the normal image data output to the image quality adjustment unit 513 are either the normal image data output from the image input unit 502 or normal image data subjected to synthesis processing to be described below. In the image quality adjustment unit 513, suppression processing for suppressing variation in a brightness of a display image caused by variation in a target brightness of a light-emitting unit (a backlight unit to be described below), for example, is applied to the normal image data on the basis of the target brightness of the light-emitting unit as the image quality adjustment processing.

Further, if necessary, the display control unit 503 performs synthesis processing to synthesize GUI image data or patch image data with the normal image data (the normal image data output from the image input unit 502 or the normal image data subjected to the image quality adjustment processing). The GUI image data is generated by a graphical user interface (GUI) control unit 514, and the patch image data are generated by a patch display unit 524.

The display control unit 503 then outputs the normal image data subjected to the image quality adjustment processing and the synthesis processing as required to the display unit 504 as display image data. When the image quality adjustment processing and the synthesis processing are not required, the normal image data is output as the display image data.

The display unit 504 displays the display image data output from the display control unit 503 on the screen. More specifically, the display unit 504 is a liquid crystal panel having a plurality of liquid crystal elements, and controls a transmittance of each liquid crystal element in accordance with the display image data. Light emitted from the light-emitting unit (the backlight unit to be described below) is then passed through the respective liquid crystal elements, and as a result, the image is displayed on the screen.

In addition to the image quality adjustment processing, the image quality adjustment unit 513 performs processing to determine the target brightness of the light emitting unit (the backlight unit to be described below) on the basis of the normal image data. For example, the target brightness is determined such that when the normal image data is light in color, the target brightness is higher than when the normal image data is dark in color. Note that the target brightness may be determined in each region so as to be higher in a region where the normal image data are light than in a region where the normal image data are dark.

The target brightness is determined using information (a function or a table) indicating a correspondence relationship between a characteristic value of the normal image data and the target brightness, for example. The characteristic value is a representative value (a maximum value, a minimum value, a mode value, a median value, an average value, or the like) or a histogram of a pixel value, or a representative value or a histogram of a brightness value, for example.

A backlight control unit 505 controls light emission by the backlight unit (light-emission control). More specifically, the backlight control unit 505 causes the backlight unit to emit light at the target brightness determined by the image quality adjustment unit 513. The backlight unit is a light-emitting unit that emits light onto a back surface of the display unit 504, and includes a direct RGB-LED backlight 506 (the first light source) and a CCFL backlight 507 (the second light source). The backlight control unit 505 performs light-emission switch processing to switch a light-emission condition of the direct RGB-LED backlight 506 and the CCFL backlight 507 in response to a request from an individual visual characteristic control unit 521.

An interface unit 516 obtains an operation signal indicating a user operation performed using an input device 515 such as a remote controller or a main body button. The interface unit 516 outputs the obtained operation signal to a function unit corresponding to the operation signal. For example, when a user operation for displaying a GUI image is performed, an operation signal (or an instruction to generate a GUI image) is output to the GUI control unit 514.

The GUI control unit 514 generates GUI image data on the basis of the operation signal output from the interface unit 516. Raw material data and so on required by the GUI image data is recorded in advance in the storage unit 511, and the GUI image data is generated using the raw material data and so on recorded in the storage unit 511.

The GUI control unit 514 outputs the generated GUI image data to the display control unit 503.

The storage unit 511 stores image data, set value data, and so on used by the display apparatus 500. Further, the storage unit 511 stores individual visual characteristic data output from the individual visual characteristic control unit 521.

The individual visual characteristic control unit 521 includes an individual visual characteristic acquisition unit 522 and an individual visual characteristic reflection unit 523.

The individual visual characteristic acquisition unit 522 performs various types of control for measuring an individual visual characteristic in response to a user operation. For example, the individual visual characteristic acquisition unit 522 performs display control to display the measurement patch (the first image) and the reference patch (the second image) in order to measure an individual visual characteristic. More specifically, the individual visual characteristic acquisition unit 522 instructs the patch display unit 524 to set patch colors, sizes, display positions, and so on of the measurement patch and the reference patch, and to generate patch image data (image data of the measurement patch and the reference patch). As a result, the patch image data are generated by the patch display unit 524, whereupon the display control unit 503 synthesizes the patch image data and the normal image data such that the measurement patch and the reference patch are displayed.

Further, the individual visual characteristic acquisition unit 522 obtains a perception result by the user in relation to the measurement patch and the reference patch displayed on the screen in response to a user operation. More specifically, the individual visual characteristic acquisition unit 522 obtains selection information indicating the measurement patch selected by the user. The individual visual characteristic acquisition unit 522 then calculates the individual visual characteristic on the basis of the obtained measurement result, and records individual visual characteristic data indicating the calculated individual visual characteristic in the storage unit 511.

Display control and perception result acquisition may be performed by different function units.

The individual visual characteristic reflection unit 523 reflects the individual visual characteristic obtained (calculated) by the individual visual characteristic acquisition unit 522 in the image quality of the display apparatus 500. More specifically, the individual visual characteristic reflection unit 523 corrects a parameter (an image quality parameter) relating to the image quality of the monitor on the basis of the individual visual characteristic. In this embodiment, a correction value for correcting a parameter used in the image quality adjustment processing is determined on the basis of the individual visual characteristic, and the determined correction value is output to the image quality adjustment unit 513. Accordingly, in the image quality adjustment unit 513, the parameter is corrected by the correction value, and image quality adjustment processing is performed using the corrected parameter. As a result, image display can be performed at an image quality reflecting the individual visual characteristic.

A system control unit 512 performs overall control of the respective function units provided in the display apparatus 500.

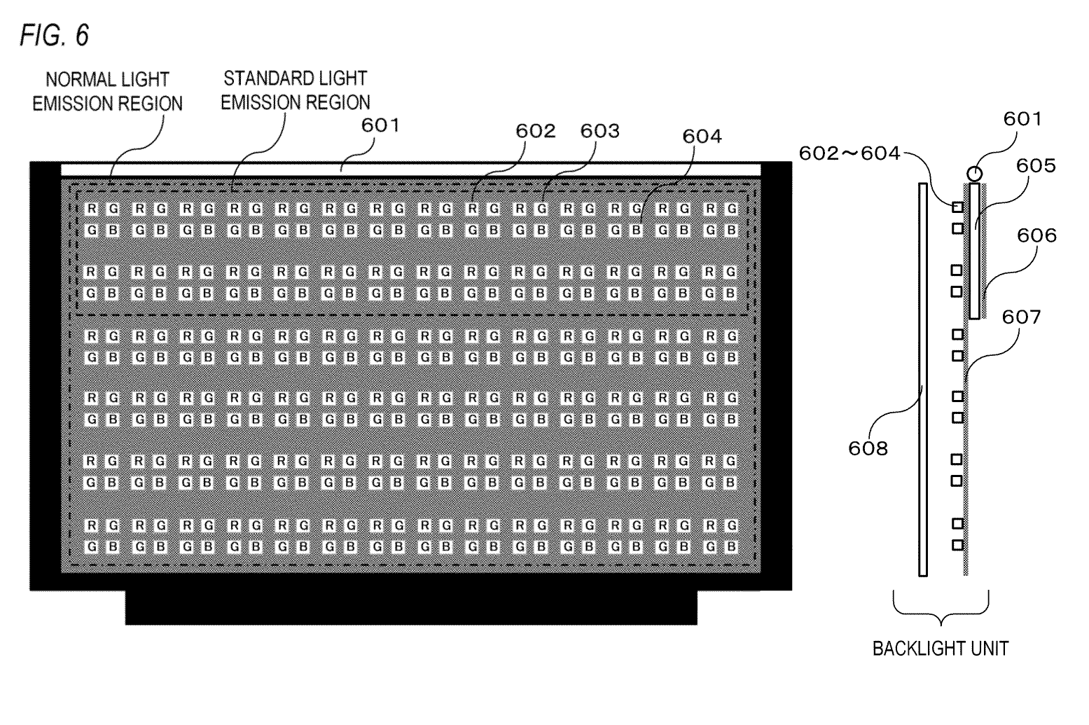

A structure of the light-emitting unit (the backlight unit) according to this embodiment will now be described using FIG. 6. A front view and a sectional view (a side view) illustrating the structure of the backlight unit according to this embodiment are shown in FIG. 6.

In this embodiment, the backlight unit is configured to be capable of emitting the first light and the second light individually in a partial region of the screen (which may also be referred to as a light-emission surface).

As described above, the backlight unit includes the direct RGB-LED backlight 506 and the CCFL backlight 507.

The CCFL backlight 507 is an edge light type backlight having a CCFL 601 and a light guiding plate 605.

The direct RGB-LED backlight 506 is a direct backlight having a plurality of R-LEDs 602, a plurality of G-LEDs 603, and a plurality of B-LEDs 604.

The CCFL 601 is disposed at an upper end of the screen. Light from the CCFL 601 enters the light guiding plate 605 from an entrance surface of the light guiding plate 605 (a surface on the side where the CCFL 601 is provided), undergoes repeated surface reflection, and then exits the light guiding plate 605 from an exit surface of the light guiding plate 605. The light entering the light guiding plate 605 is reflected and scattered by a reflective sheet 606, for example.

The light guiding plate 605 is disposed such that a region of the exit surface thereof matches a standard light emission region, which is a region in an upper portion of the screen.

The CCFL 601 is fixed to the light guiding plate 605, and the light guiding plate 605 is fixed to a substrate 607.

Note that the positions of the CCFL 601 and the entrance surface of the light guiding plate 605 are not limited to the upper end of the screen. Further, the position of the exit surface of the light guiding plate 605 is not limited to the upper portion of the screen. For example, the CCFL 601 and the light guiding plate 605 may be disposed such that the exit surface is positioned in a central part of the screen, while the CCFL 601 and the entrance surface of the light guiding plate 605 are positioned in the region of the screen.

The plurality of R-LEDs 602, the plurality of G-LEDs 603, and the plurality of B-LEDs 604 are arranged over the entire region (a normal light emission region) of the screen such that intervals between the LEDs are substantially constant. The plurality of R-LEDs 602, the plurality of G-LEDs 603, and the plurality of B-LEDs 604 are fixed to the substrate 607.

Light emitted from the plurality of R-LEDs 602, the plurality of G-LEDs 603, and the plurality of B-LEDs 604 is diffused by a diffusion sheet 608. As a result, light having no brightness unevenness is emitted over the entire screen from the direct RGB-LED backlight 506. Similarly, the light that exits the exit surface of the light-guiding plate 605 is diffused by the diffusion sheet 608. As a result, light having no brightness unevenness is emitted within the standard light emission region from the CCFL backlight 507.

By employing the backlight unit configured as described above, image display can be performed in the standard light emission region using a light source (a standard light source; the CCFL backlight 507) that emits light that produces little deviation in a perceived color from user to user. Hence, in this embodiment, by displaying the reference patch in the standard light emission region, the reference patch can be used as a reference when measuring an individual visual characteristic, and as a result, the individual visual characteristic can be measured with a high degree of precision.

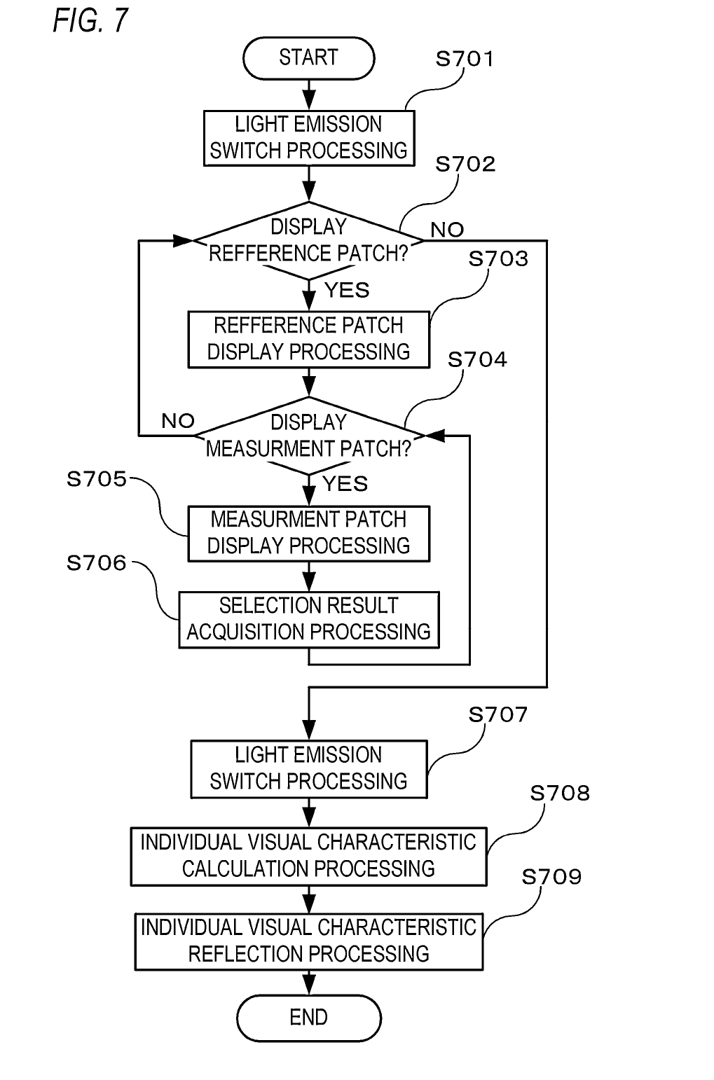

An example of a flow of processing executed by the display apparatus 500 according to this embodiment will now be described using FIG. 7.

In S701, the display apparatus 500 performs light emission switch processing in response to a user operation to start measuring an individual visual characteristic.

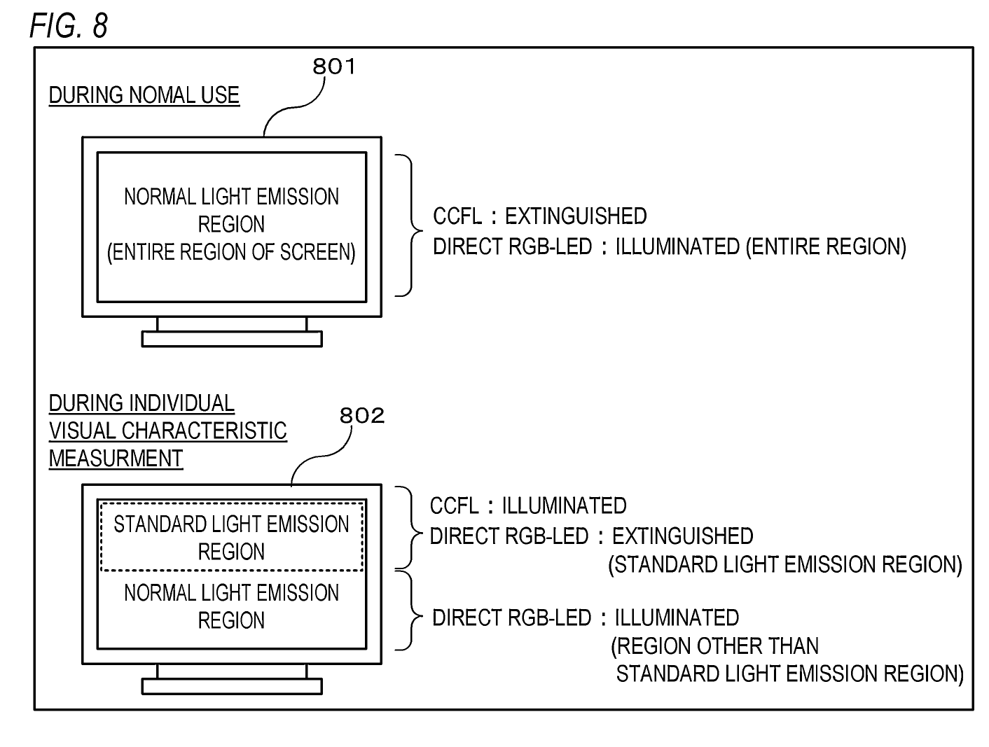

The light emission switch processing will now be described in detail using FIG. 8.

A reference numeral 801 indicates the light emission condition of the backlight unit during normal use of the monitor, for example during an image editing operation or a data conversion operation. During normal use, image display is performed by illuminating the direct RGB-LED backlight over the entire region (the normal light-emission region) of the screen. At this time, the CCFL backlight is extinguished.

A reference numeral 802 indicates the light-emission condition of the backlight unit during individual visual characteristic measurement. During individual visual characteristic measurement, the CCFL backlight is illuminated and the direct RGB-LED backlight is extinguished in the standard light emission region. In the remaining region (a region obtained by subtracting the standard light-emission region from the normal light-emission region), the direct RGB-LED backlight is illuminated. Image display is then performed in this light-emission condition.

In S701, the light emission condition of the backlight unit is switched from the light-emission condition during normal use to the light emission condition during individual visual characteristic measurement, as described above. The light emission switch processing is performed at a timing where an operating mode of the display apparatus 500 shifts from a normal use mode to a measurement mode in response to a user operation to start measuring an individual visual characteristic. In the light-emission switch processing, the individual visual characteristic acquisition unit 522 issues a light-emission switch instruction to the backlight control unit 505. In response to the light-emission switch instruction, the backlight control unit 505 controls light emission by the direct RGB-LED backlight 506 and the CCFL backlight 507.

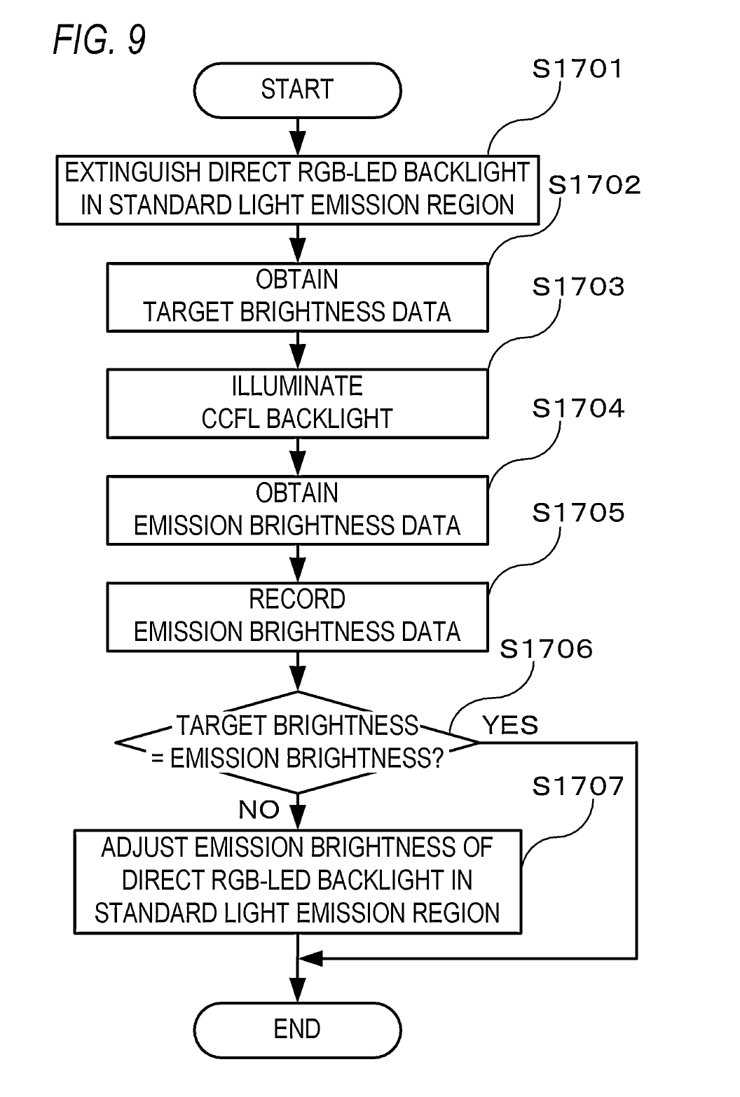

An example of a flow of the light emission switch processing performed in S701 will now be described using FIG. 9.

In S1701, the individual visual characteristic acquisition unit 522 issues an OFF instruction to the backlight control unit 505 to extinguish the direct RGB-LED backlight in the standard light emission region. In response to the OFF instruction, the backlight control unit 505 extinguishes the direct RGB-LED backlight in the standard light-emission region. In other words, the backlight control unit 505 switches the light-emission condition of the direct RGB-LED backlight in the standard light-emission region from an ON condition (an illuminated condition) to an OFF condition (an extinguished condition).

In S1702, the individual visual characteristic acquisition unit 522 obtains target brightness data indicating the target brightness (a target measurement brightness) of the backlight unit during individual visual characteristic measurement from the storage unit 511. The target brightness data obtained in S1702 are data indicating the target brightness (the target measurement brightness) to be set over the entire region of the screen during individual visual characteristic measurement. The target measurement brightness may be a fixed value determined in advance, but does not have to be. For example, the value of the target measurement brightness may be set and modified in response to user operations.

In S1703, the individual visual characteristic acquisition unit 522 issues an ON instruction to the backlight control unit 505 to illuminate the CCFL backlight (in the standard light emission region). In response to the ON instruction, the backlight control unit 505 switches the light-emission condition of the CCFL backlight from the OFF condition to the ON condition. Further, the backlight control unit 505 adjusts an emission brightness of the CCFL backlight so as to match the target measurement brightness indicated by the target brightness data obtained in S1702.

In S1704, the individual visual characteristic acquisition unit 522 obtains emission brightness data indicating the emission brightness of the currently illuminated direct RGB-LED backlight. In other words, emission brightness data indicating the emission brightness of the direct RGB-LED backlight in the normal light emission region are obtained. The emission brightness data are calculated from a detection value of a brightness sensor provided in the backlight unit, for example.

In S1705, the individual visual characteristic acquisition unit 522 records the emission brightness data obtained in S1704 in the storage unit 511. The recorded emission brightness data are used as data indicating the target brightness of the backlight unit when the individual visual characteristic measurement is complete. As a result, a display brightness used during normal display can be aligned on either side of the individual visual characteristic measurement.

In S1706, the individual visual characteristic acquisition unit 522 compares the target brightness data obtained in S1702 with the emission brightness data obtained in S1704. When the value of the emission brightness indicated by the emission brightness data is identical to the value of the target measurement brightness indicated by the target brightness data, the processing is terminated. When the value of the emission brightness indicated by the emission brightness data differs from the value of the target measurement brightness indicated by the target brightness data, the processing advances to S1707. In other words, when the brightness of the light emitted by the direct RGB-LED backlight in the normal light-emission region is identical to the target measurement brightness, the processing is terminated, and when this is not the case, the processing advances to S1707.

In S1707, the individual visual characteristic acquisition unit 522 issues an adjustment instruction to the backlight control unit 505 to adjust the emission brightness of the direct RGB-LED backlight in the normal light emission region. Here, the adjustment instruction is issued to align the emission brightness of the direct RGB-LED backlight in the normal light emission region with the target measurement brightness. In response to the adjustment instruction, the backlight control unit 505 adjusts the emission brightness of the direct RGB-LED backlight in the normal light-emission region so that the emission brightness of the direct RGB-LED backlight in the normal light-emission region matches the target measurement brightness.

In the example described in this embodiment, the emission brightness of the direct RGB-LED backlight in the normal light-emission region is adjusted to match the target measurement brightness, but the method of adjusting the emission brightness is not limited thereto. For example, the emission brightness of the CCFL backlight may be adjusted so as to match the emission brightness of the direct RGB-LED backlight in the normal light-emission region.

The description will now return to FIG. 7.

In S702, the display apparatus 500 determines whether or not it is necessary to display a reference patch serving as a reference for measuring an individual visual characteristic. More specifically, the individual visual characteristic acquisition unit 522 determines whether or not all reference patches prepared in advance have already been displayed. When all of the reference patches have already been displayed, the individual visual characteristic acquisition unit 522 determines that it is not necessary to display a reference patch, and the processing advances to S707. When a reference patch that has not yet been displayed exists, the individual visual characteristic acquisition unit 522 determines that it is necessary to display the reference patch, and the processing advances to S703. The determination as to whether or not all of the reference patches have already been displayed is made by having the individual visual characteristic acquisition unit 522 obtain reference patch information from the storage unit 511 and compare display completion information with the reference patch information. The reference patch information is information indicating a plurality of reference patches prepared in advance, and the display completion information is information indicating reference patches that have already been displayed. The individual visual characteristic acquisition unit 522 is provided with the display completion information in advance, and updates the display completion information every time a reference patch is displayed. The reference patch information is recorded in the storage unit 511 in advance.

In S703, the display apparatus 500 displays the reference patch in the standard light emission region, which is the region where the CCFL backlight is illuminated. The color, size, position, and so on of the display subject reference patch are determined by the individual visual characteristic acquisition unit 522. More specifically, the color of a reference patch that has not yet been displayed, from among the plurality of reference patches prepared in advance, is set as the color of the displayed reference patch. Further, the position and size of the display subject reference patch are determined so that the user can compare the reference patch with the measurement patch easily. As a result, as shown in FIG. 4, for example, a plurality of reference patches (a plurality of reference patches of identical sizes and colors) of an easily viewable size are displayed in positions close to a plurality of measurement patches displayed outside the standard light-emission region. Reference patch display processing is realized by the individual visual characteristic acquisition unit 522 by issuing a display request (an instruction to generate patch image data relating to the reference patch) to the patch display unit 524.

In S704, the display apparatus 500 determines whether or not it is necessary to display a plurality of measurement patches to be selected by the user in order to measure the individual visual characteristic. The determination as to whether or not it is necessary to display the measurement patches is made on the basis of measurement result information indicating a measurement patch selected by the user in relation to a reference patch displayed in the past. When the individual visual characteristic can be calculated in relation to the color of the displayed reference patch on the basis of the measurement result information, it is determined not to be necessary to display the measurement patches, and the processing returns to S702. When the individual visual characteristic cannot be calculated in relation to the color of the displayed reference patch on the basis of the measurement result information, it is determined to be necessary to display the measurement patches, and the processing advances to S705. The determination as to whether or not it is necessary to display the measurement patches is made by the individual visual characteristic acquisition unit 522. More specifically, the individual visual characteristic acquisition unit 522 accumulates information indicating measurement patches selected by the user in relation to reference patches displayed in the past, and analyzes the selection results of the user using the accumulated information. The individual visual characteristic acquisition unit 522 then determines whether or not it is necessary to display the measurement patches on the basis of the analysis result.

In S705, the display apparatus 500 displays the measurement patches. The measurement patches are displayed in the region (the region obtained by subtracting the standard light emission region from the normal light emission region) illuminated by the direct RGB-LED backlight. The colors, sizes, positions, and so on of the display subject measurement patches are determined by the individual visual characteristic acquisition unit 522. In this embodiment, as shown in FIG. 4, a plurality of measurement patches having identical sizes and different colors are displayed. Processing for displaying the measurement patches is realized by having the individual visual characteristic acquisition unit 522 issue a display request (an instruction to generate patch image data for the measurement patches) to the patch display unit 524.

In S706, the display apparatus 500 obtains a selection result by the user in relation to the measurement patches. The user compares the reference patch displayed in S703 with the plurality of differently-colored measurement patches displayed in S705. The user then selects the measurement patch perceived to be closest to the displayed reference patch from the plurality of displayed measurement patches. The measurement patch is selected using an input device such as a remote controller or a main body button. Selection information (the selection result) indicating the selected measurement patch is obtained by the individual visual characteristic acquisition unit 522 via the interface unit 516. The obtained selection information is recorded (accumulated) as measurement result information. Once the measurement patch has been selected, the processing returns to S702.

The processing of S702 to S706 is performed repeatedly until it is determined not to be necessary to display a reference patch in S702, at which point the processing advances to S707.

In S707, the display apparatus 500 performs light emission switch processing accompanying completion of the individual visual characteristic measurement. In S707, the light emission condition of the backlight is switched from the light emission condition during individual visual characteristic measurement, shown in FIG. 8, to the light emission condition during normal use. In S707, the light emission switch processing is performed at a timing where the processing up to S706 is completed and the operating mode of the display apparatus 500 shifts from the measurement mode to the normal use mode. In S707, the individual visual characteristic acquisition unit 522 issues a light emission switch instruction to the backlight control unit 505. In response to the light emission switch instruction, the backlight control unit 505 controls light emission by the direct RGB-LED backlight 506 and the CCFL backlight 507. More specifically, the backlight control unit 505 extinguishes the illuminated CCFL backlight and illuminates the direct RGB-LED backlight over the entire region of the screen. Image display is then performed in the resulting light emission condition.

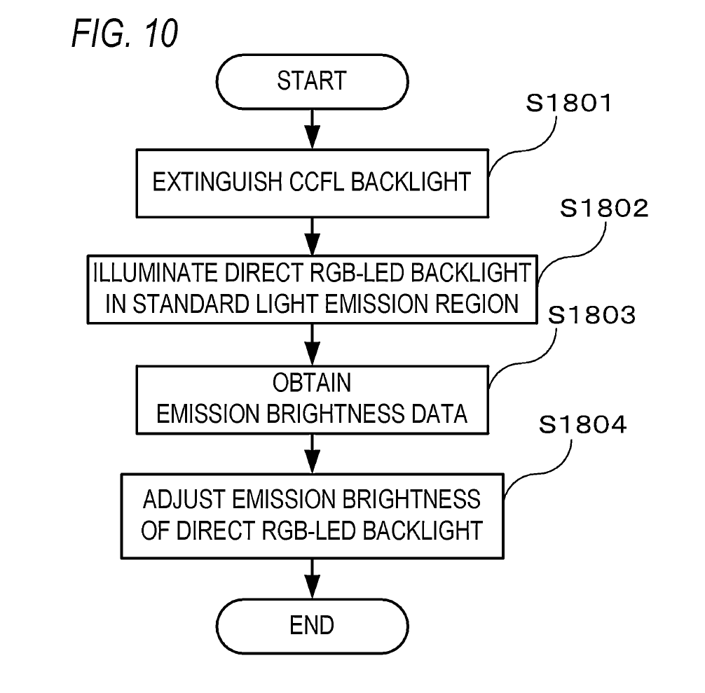

An example of a flow of the light emission switch processing performed in S707 will now be described using FIG. 10.

In S1801, the individual visual characteristic acquisition unit 522 issues an OFF instruction to the backlight control unit 505 to extinguish the CCFL backlight (in the standard light-emission region). In response to the OFF instruction, the backlight control unit 505 switches the light emission condition of the CCFL backlight from the ON condition to the OFF condition.

In S1802, the individual visual characteristic acquisition unit 522 issues an ON instruction to the backlight control unit 505 to illuminate the direct RGB-LED backlight in the standard light-emission region. In response to the ON instruction, the backlight control unit 505 switches the light emission condition of the direct RGB-LED backlight in the standard light emission region from the OFF condition to the ON condition.

In S1803, the individual visual characteristic acquisition unit 522 obtains the emission brightness data (the data indicating the emission brightness of the direct RGB-LED backlight prior to measurement) recorded in the storage unit 511 during the light emission switch processing of S701.

In S1804, the individual visual characteristic acquisition unit 522 issues an adjustment instruction to the backlight control unit 505 to adjust the emission brightness of the direct RGB-LED backlight. Here, an adjustment instruction is issued to align the emission brightness of the direct RGB-LED backlight over the entire screen with the value of the emission brightness data obtained in S1803. In response to the adjustment instruction, the backlight control unit 505 adjusts the emission brightness of the direct RGB-LED backlight so that the emission brightness of the direct RGB-LED backlight over the entire screen matches the value of the emission brightness data obtained in S1803.

The description will now return to FIG. 7.

In S708, the display apparatus 500 calculates the individual visual characteristic. The individual visual characteristic is calculated on the basis of the measurement result information obtained in S702 to S706. More specifically, the individual visual characteristic acquisition unit 522 calculates difference data for each reference patch on the basis of the measurement result information, the difference data indicating a difference between the color of the reference patch (the value of the image data) and the color of the measurement patch selected by the user in relation to the reference patch. The individual visual characteristic acquisition unit 522 then calculates difference data for colors other than the color of the reference patch on the basis of the measurement result information and the calculated difference data. As a result, an individual visual characteristic is obtained for all of the colors that can be displayed by the display apparatus 500. Individual visual characteristic information indicating the obtained individual visual characteristic is recorded in the storage unit 511.

In S709, the display apparatus 500 reflects the individual visual characteristic obtained (i.e. calculated) in S708 in the image quality of the display apparatus 500. More specifically, the individual visual characteristic reflection unit 523 obtains the individual visual characteristic information obtained (calculated) in S708 from the storage unit 511. The individual visual characteristic reflection unit 523 then creates a color conversion lookup table on the basis of the obtained individual visual characteristic information, and records the color conversion lookup table in the storage unit 511. Next, the image quality adjustment unit 513 obtains the recorded color conversion lookup table from the storage unit 511, and executes color conversion processing (image quality adjustment processing). Hence, when an image subjected to the color conversion processing is displayed, the individual visual characteristic obtained (calculated) in S708 is reflected in the image quality of the display apparatus 500.

Note that when a user (i.e. a measurement subject) whose individual visual characteristic has already been measured uses the display apparatus 500, the individual visual characteristic measurement may be omitted, and the color conversion lookup table may be generated and used on the basis of previously obtained individual visual characteristic information. Further, when a previously-measured user uses the display apparatus 500, generation of the lookup table may also be omitted, and a previously generated lookup table may be used.

Furthermore, when a previous measurement date is at least a predetermined time prior to the current time, the likelihood that the individual visual characteristic has changed is high, and therefore measurement may be performed anew.

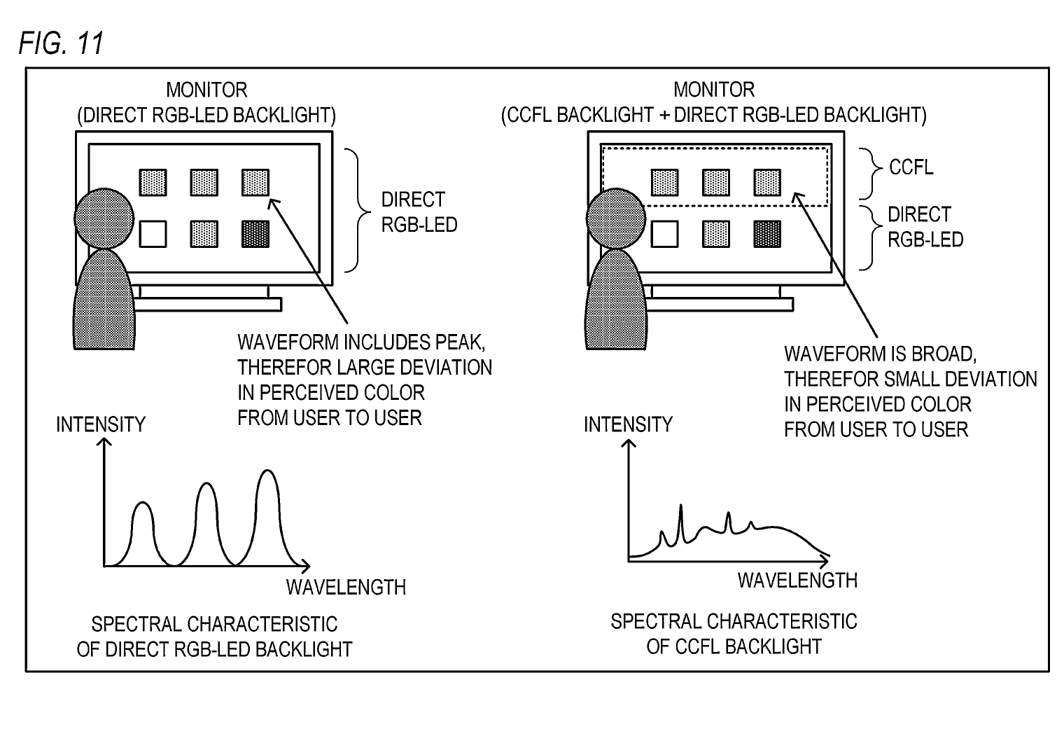

Effects of this embodiment will now be described using FIG. 11.

As shown in FIG. 11, a waveform of a spectral characteristic of a direct RGB-LED backlight includes sharp peaks at specific wavelengths. Hence, with a monitor that uses only a direct RGB-LED backlight, only images that produce large deviations in the perceived color from user to user can be displayed, and it is therefore very difficult to display an image that can serve as a reference for measuring an individual visual characteristic.

In this embodiment, the second light source (the CCFL backlight) is used in addition to the first light source (the direct RGB-LED backlight) used during normal display. As shown in FIG. 11, light from the second light source has a spectral characteristic in which the shape of the spectral waveform is comparatively broad. Therefore, little deviation in the perceived color occurs from user to user, and little variation in the perceived color occurs due to variation in the field of vision. Hence, an image displayed using light from the second light source produces little deviation in the perceived color from user to user. More specifically, by using light from the second light source, a displayed image can be observed at a similar perceived color to the color perceived when a printed material is observed under a D50 fluorescent lamp having a high color rendering property, which is used conventionally as standard environmental light. Accordingly, an image displayed using light from the second light source can be used as a reference for measuring an individual visual characteristic. By employing an image displayed using light from the second light source as a reference for measuring an individual visual characteristic, a highly precise individual visual characteristic can be obtained without relying on environmental light.

According to this embodiment, as described above, when the individual visual characteristic of the user is measured, the measurement patch (the first image) is displayed in the display region that includes the region where the first image is to be displayed by emitting the first light from the backlight unit. The reference patch (the second image) is displayed in the display region that includes the region where the second image is to be displayed by emitting the second light, which has a broader emission spectrum distribution than the first light, from the backlight unit. In so doing, an image that produces little deviation in the perceived color from user to user can be displayed as the reference patch, and therefore the reference patch can be used as a reference for measuring the individual visual characteristic. As a result, the individual visual characteristic can be measured with a high degree of precision.

Note that in this embodiment, an example of a case in which the first light and the second light can be emitted individually only in a partial region (a predetermined region) of the screen was described. However, the backlight unit is not limited to this configuration, and instead, for example, the light may be switched over the entire region of the screen. In this case, there are no particular limitations on the regions in which the first image and the second image are displayed, as long as the first light is emitted in the region displaying the first image and the second light is emitted in the region displaying the second image.

In this embodiment, an example in which light emitted by driving only the second light source is used as the second light was described, but the present invention is not limited thereto, and light emitted by driving both the first light source and the second light source may be used as the second light. In other words, both the direct RGB-LED backlight and the CCFL backlight may be illuminated in the standard light emission region such that the reference patch is displayed in the standard light emission region under this light emission condition. Synthesized light obtained by synthesizing the light from the direct RGB-LED backlight and the light from the CCFL backlight has a spectral characteristic with a broader emission spectrum distribution than that of the light from the direct RGB-LED backlight. By using this synthesized light, therefore, it is possible to display an image that produces less deviation in the perceived color from user to user than an image displayed using light from the direct RGB-LED backlight. Hence, by employing an image displayed using the synthesized light as a reference for measuring an individual visual characteristic, a highly precise individual visual characteristic can be measured. Note, however, that the light from the CCFL backlight has a spectral characteristic with a broader emission spectrum distribution than the synthesized light, and therefore image display producing less deviation in the perceived color from user to user can be realized when the light from the CCFL backlight is used than when the synthesized light is used.

### Second Embodiment

A display apparatus and a control method thereof according to a second embodiment of the present invention will now be described.

In the first embodiment, an example in which an edge light-type backlight having a CCFL is used as the second light source was described. In this embodiment, an example in which a direct backlight having a plurality of colored LEDs that emit light of different wavelengths from the light emitted by the colored LEDs constituting the first light source is used as the second light source will be described.

Note that in this embodiment, similarly to the first embodiment, a direct backlight having a plurality of colored LEDs is used as the first light source. More specifically, a direct RGB-LED backlight having R-LEDs, G-LEDs, and B-LEDs is used as the first light source.

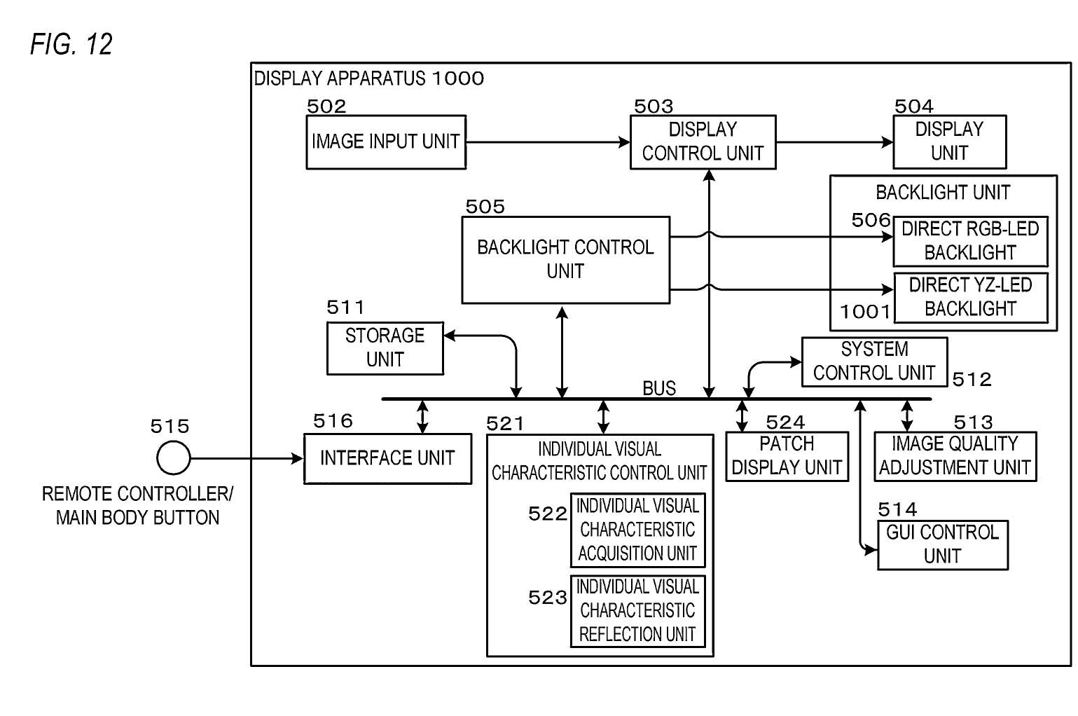

A configuration of the display apparatus according to this embodiment will now be described using FIG. 12. FIG. 12 is a block diagram showing an example of the configuration of a display apparatus 1000 according to this embodiment. Note that identical function units with those of the first embodiment (FIG. 5) have been allocated identical reference numerals, and description thereof has been omitted.

As shown in FIG. 12, in this embodiment, the backlight unit includes a direct YZ-LED backlight 1001 instead of the CCFL backlight 507. All other portions of the figure are the same as FIG. 5 illustrating the first embodiment.

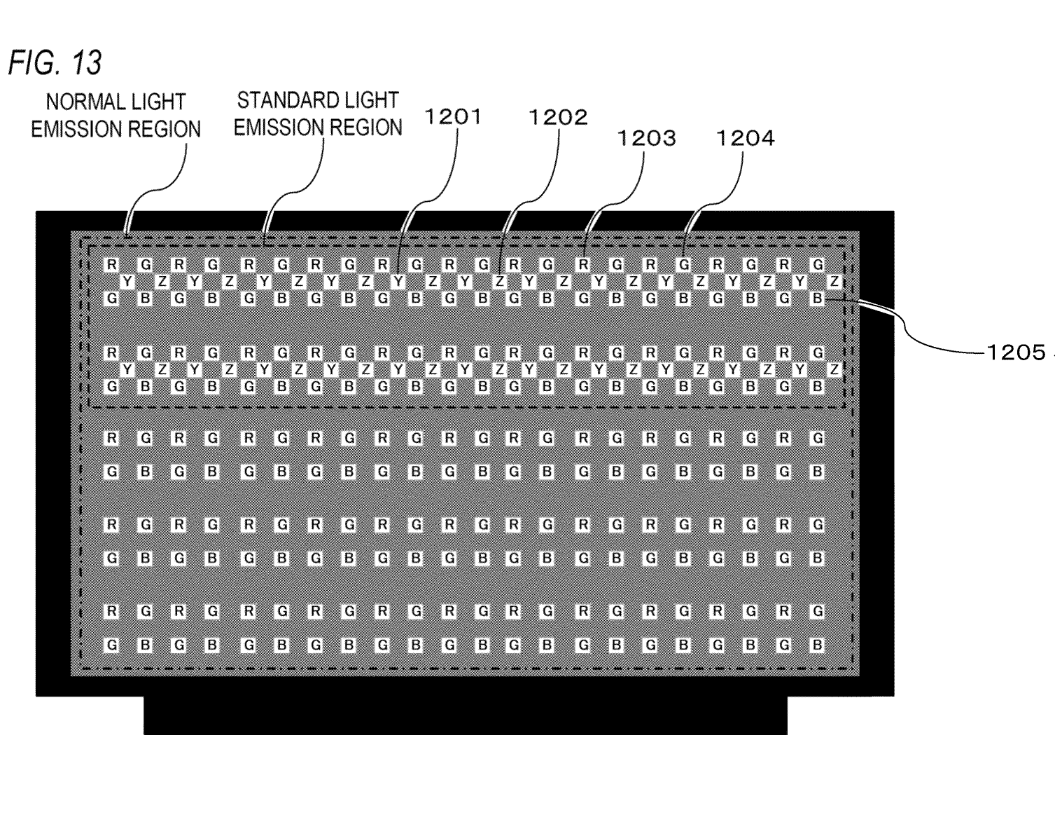

A structure of a light emission unit (the backlight unit) according to this embodiment will now be described using FIG. 13. FIG. 13 is a front view showing the structure of the backlight unit according to this embodiment. In this embodiment, the backlight unit is configured to be capable of emitting the first light and the second light individually in a partial region of the screen.

As described above, the backlight unit includes the direct RGB-LED backlight 506 (the first light source) and the direct YZ-LED backlight 1001 (the second light source).

The direct RGB-LED backlight is configured identically with the first embodiment. More specifically, the direct RGB-LED backlight is a direct RGB-LED backlight including a plurality of R-LEDs 1203, a plurality of G-LEDs 1204, and a plurality of B-LEDs 1205.

The direct YZ-LED backlight 1001 is a direct backlight including a plurality of Y-LEDs 1201 and a plurality of Z-LEDs 1202. The Y-LEDs are colored LEDs that emit light of a wavelength between the wavelength of the light emitted by the R-LEDs and the wavelength of the light emitted by the G-LEDs. In other words, the Y-LEDs are colored LEDs having a spectral characteristic between the spectral characteristic of the R-LEDs and the spectral characteristic of the G-LEDs. The Z-LEDs are colored LEDs that emit light of a wavelength between the wavelength of the light emitted by the G-LEDs and the wavelength of the light emitted by the B-LEDs. In other words, the Z-LEDs are colored LEDs having a spectral characteristic between the spectral characteristic of the G-LEDs and the spectral characteristic of the B-LEDs.

The plurality of R-LEDs 1203, the plurality of G-LEDs 1204, and the plurality of B-LEDs 1205 are arranged in a similar manner to the first embodiment. In other words, the plurality of R-LEDs 1203, the plurality of G-LEDs 1204, and the plurality of B-LEDs 1205 are arranged over the entire region (the normal light emission region) of the screen such that intervals between the LEDs are substantially constant.

The plurality of Y-LEDs 1201 and the plurality of Z-LEDs 1202 are arranged over the entire standard light emission region such that intervals between the LEDs are substantially constant.

By employing the backlight unit having the configuration described above, image display can be performed in the standard light emission region using backlight light (light from the backlight unit) that produces a small amount of deviation in the perceived color from user to user. Hence, in this embodiment, by displaying the reference patch in the standard light emission region, the reference patch can be used as a reference for measuring an individual visual characteristic, and as a result, the individual visual characteristic can be measured with a high degree of precision. The reason why backlight light that produces a small amount of deviation in the perceived color from user to user is obtained in the standard light emission region will be described below.

The colored LEDs of the second light source are not limited to the Y-LEDs and Z-LEDs described above, and any LEDs that emit light having a different wavelength from the light emitted by the colored LEDs of the first light source may be used.

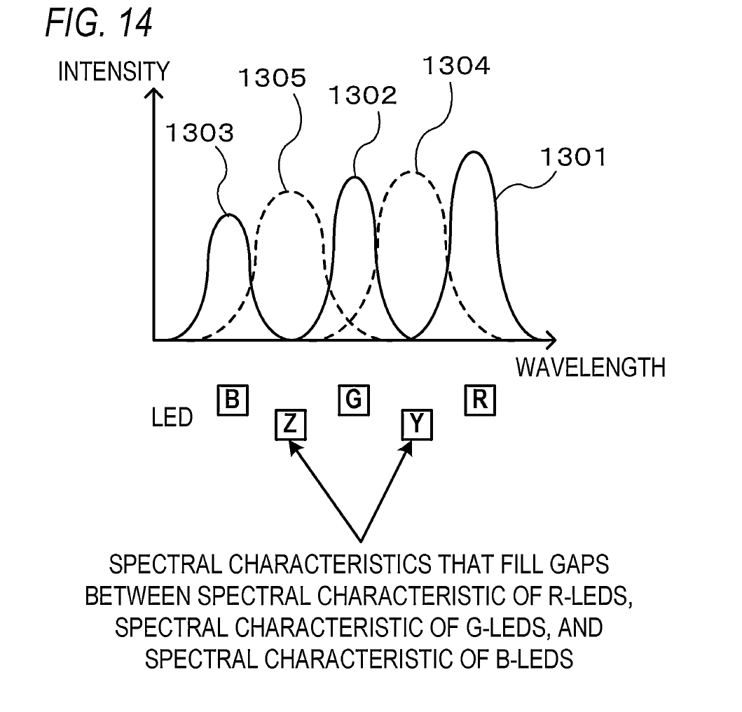

A method of obtaining backlight light that produces a small amount of deviation in the perceived color from user to user in the standard light emission region will now be described using FIG. 14. FIG. 14 is a view showing spectral characteristics of light emitted from respective light emitting elements.

As shown in FIG. 14, a spectral characteristic 1301 of the R-LED, a spectral characteristic 1302 of the G-LED, and a spectral characteristic 1303 of the B-LED respectively have peaks at specific wavelengths.

Therefore, light having a sharp peak at a specific wavelength is emitted from the direct RGB-LED backlight. When image display is performed using this type of light, large deviations in the perceived color occur from user to user. In this embodiment, similarly to the first embodiment, the light from the direct RGB-LED backlight is used as the first light.

A spectral characteristic 1304 of the Y-LED fills a gap between the spectral characteristic 1301 of the R-LED and the spectral characteristic 1302 of the G-LED. More specifically, the spectral characteristic 1304 of the Y-LED has a peak between the peak of the spectral characteristic 1301 of the R-LED and the peak of the spectral characteristic 1302 of the G-LED.

A spectral characteristic 1305 of the Z-LED fills a gap between the spectral characteristic 1302 of the G-LED and the spectral characteristic 1303 of the B-LED. More specifically, the spectral characteristic 1305 of the Z-LED has a peak between the peak of the spectral characteristic 1302 of the G-LED and the peak of the spectral characteristic 1303 of the B-LED.

Hence, by synthesizing the light from the direct RGB-LED backlight and the light from the direct YZ-LED backlight, light (synthesized light) having a broader emission spectrum distribution than the light from the direct RGB-LED backlight can be obtained. In other words, light that produces a small amount of deviation in the perceived color from user to user can be obtained.

In this embodiment, therefore, synthesized light emitted by driving both the direct RGB-LED backlight and the direct YZ-LED backlight is used as the second light.

A flow of processing performed by the display apparatus 1000 according to this embodiment is identical with that of the first embodiment (FIG. 7). However, emission brightness switch processing (the processing of S701 and S707) differs from the first embodiment.

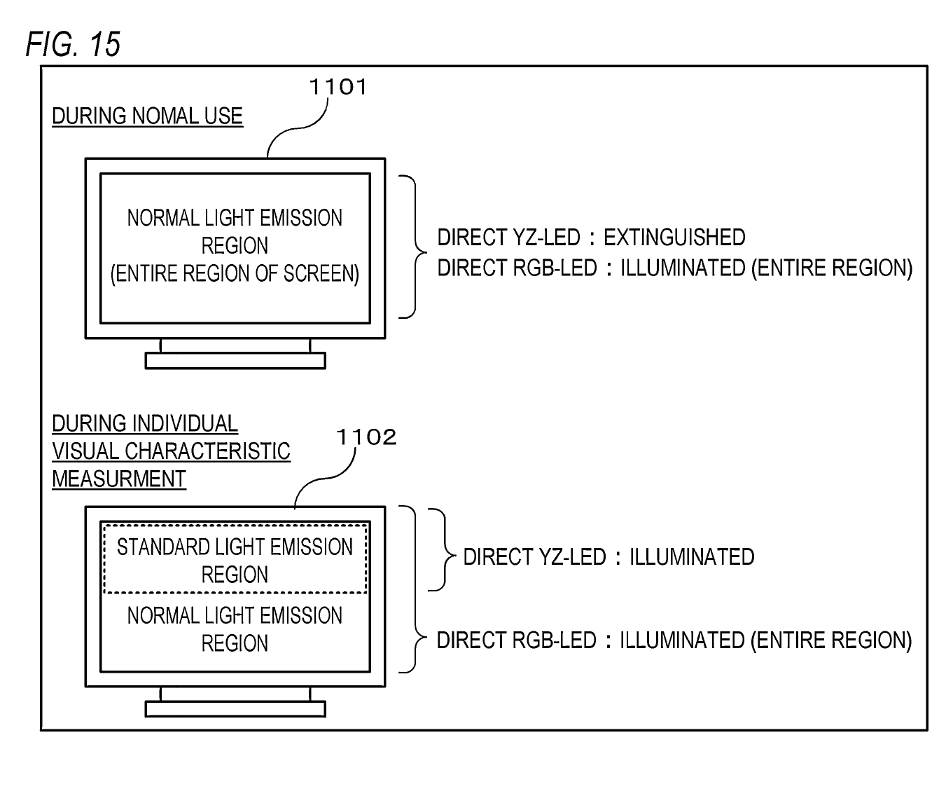

The light emission switch processing according to this embodiment will now be described using FIG. 15.

A reference numeral 1101 indicates the light emission condition of the backlight unit during normal use of the monitor, for example during an image editing operation or a data conversion operation. During normal use, image display is performed by illuminating the direct RGB-LED backlight over the entire region (the normal light emission region) of the screen. More specifically, image display is performed by illuminating all of the R-LEDs, all of the G-LEDs, and all of the B-LEDs. At this time, the direct YZ-LED backlight is extinguished. More specifically, all of the Y-LEDs and all of the Z-LEDs are extinguished.

A reference numeral 1102 indicates the light emission condition of the backlight unit during individual visual characteristic measurement. During individual visual characteristic measurement, the direct RGB-LED backlight is illuminated over the entire normal light emission region, and the direct YZ-LED backlight is illuminated in the standard light emission region. Image display is then performed in this light emission condition. More specifically, image display is performed by illuminating all of the LEDs (all of the Y-LEDs, all of the Z-LEDs, all of the R-LEDs, all of the G-LEDs, and all of the B-LEDs). As a result, both the direct RGB-LED backlight and the direct YZ-LED backlight are illuminated in the standard light emission region, while only the direct RGB-LED backlight is illuminated in the remaining region (the region obtained by subtracting the standard light emission region from the normal light emission region).

In S701, the light emission condition of the backlight unit is switched from the light emission condition during normal use to the light emission condition during individual visual characteristic measurement, as described above. In S707, the light emission condition of the backlight is switched from the light emission condition during individual visual characteristic measurement to the light emission condition during normal use.

As described above, in this embodiment, similarly to the first embodiment, an image that produces little deviation in the perceived color from user to user can be displayed as the reference patch, and therefore the reference patch can be used as a reference for measuring an individual visual characteristic. As a result, the individual visual characteristic can be measured with a high degree of precision.

Further, according to this embodiment, only LEDs are used as the light emitting elements, and therefore a reduction in power consumption can be achieved in comparison with the first embodiment.

### Third Embodiment

A display apparatus and a control method thereof according to a third embodiment of the present invention will now be described. In the second embodiment, the direct YZ-LED backlight is used as the second light source, but in this embodiment, a direct W-LED backlight is used as the second light source.

Note that only differences with the second embodiment will be described below, and description of configurations and so on that are identical to the second embodiment will be omitted.

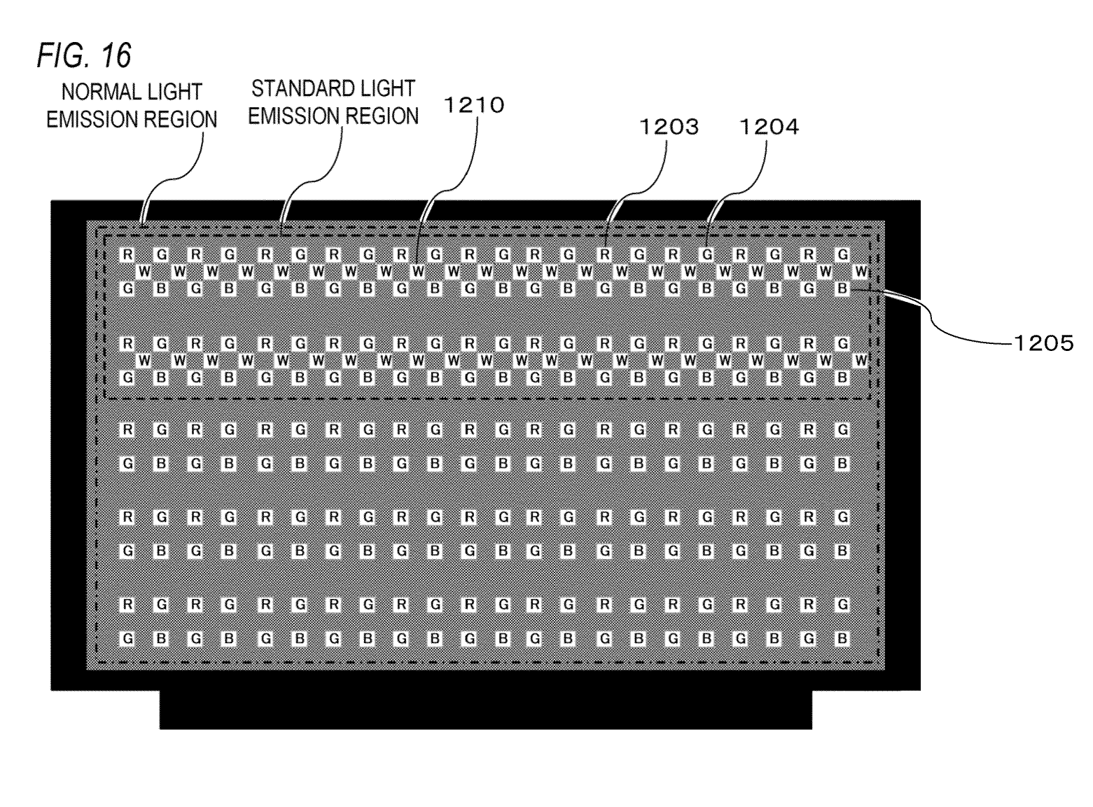

A structure of a light emission unit (the backlight unit) according to this embodiment will now be described using FIG. 16. FIG. 16 is a front view showing the structure of the backlight unit according to this embodiment. In this embodiment, the backlight unit is configured to be capable of emitting the first light and the second light individually in a partial region of the screen.

The backlight unit according to this embodiment includes a direct RGB-LED backlight (the first light source) and a direct W-LED backlight (the second light source).

The direct W-LED backlight is a direct backlight including a plurality of W-LEDs 1210. The W-LEDs are white LEDs that emit white light. The plurality of W-LEDs 1210 are arranged over the entire standard light emission region such that intervals between the LEDs are substantially constant.

The direct RGB-LED backlight is configured identically with the second embodiment, and therefore description thereof has been omitted.

By employing the backlight unit configured as described above, image display can be performed in the standard light emission region using backlight light that produces a small amount of deviation in the perceived color from user to user. Hence, in this embodiment, by displaying the reference patch in the standard light-emission region, the reference patch can be used as a reference for measuring an individual visual characteristic, and as a result, the individual visual characteristic can be measured with a high degree of precision. The reason why backlight light that produces a small amount of deviation in perceived color from user to user is obtained in the standard light-emission region will be described below.

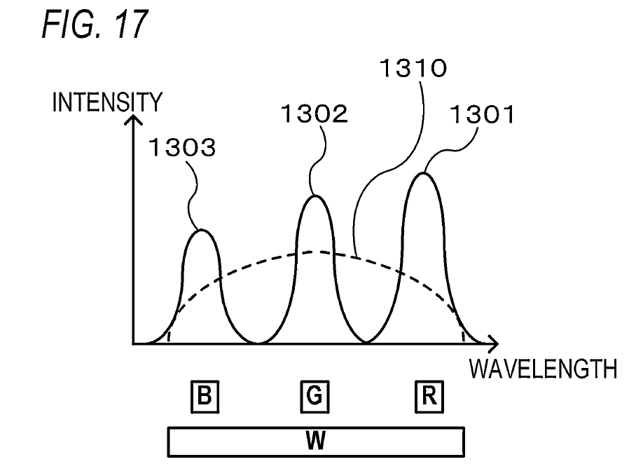

A method of obtaining backlight light that produces a small amount of deviation in the perceived color from user to user in the standard light-emission region will now be described using FIG. 17. FIG. 17 is a view showing spectral characteristics of light emitted from respective light emitting elements.

In this embodiment, similarly to the second embodiment, the light from the direct RGB-LED backlight is used as the first light.

A spectral characteristic 1310 of the W-LED has a waveform exhibiting a broader emission spectrum distribution than the spectral characteristics 1301 to 1303 of R-LED, G-LED and B-LED respectively. Therefore, by driving the direct W-LED backlight, light that produces a smaller amount of deviation in the perceived color from user to user than the light from the direct RGB-LED backlight can be obtained.

Note that the light from the direct W-LED backlight produces a smaller amount of deviation in the perceived color from user to user than the light from the direct RGB-LED backlight. Further, synthesized light obtained by synthesizing the light from the direct RGB-LED backlight with the light from the direct W-LED backlight likewise produces a smaller amount of deviation in the perceived color from user to user than the light from the direct RGB-LED backlight.

Hence, in this embodiment, image display is performed during normal use by illuminating the direct RGB-LED backlight over the entire region (the normal light emission region) of the screen. At this time, the direct W-LED backlight is extinguished.

When measuring an individual visual characteristic, the direct RGB-LED backlight is illuminated over the entire normal light emission region, and the direct W-LED backlight is illuminated in the standard light emission region. Image display is then performed in this light emission condition. As a result, both the direct RGB-LED backlight and the direct W-LED backlight are illuminated in the standard light emission region, while in the remaining region (the region obtained by subtracting the standard light emission region from the normal light emission region) only the direct RGB-LED backlight is illuminated.

Note that during individual visual characteristic measurement, the direct W-LED backlight alone may be illuminated in the standard light emission region and the direct RGB-LED backlight alone may be illuminated in the remaining region. In other words, during individual visual characteristic measurement, the W-LEDs arranged in the standard light-emission region may be illuminated while the R-LEDs, G-LEDs, and B-LEDs arranged in the standard light emission region are extinguished. Meanwhile, the R-LEDs, G-LEDs, and B-LEDs arranged in the region other than the standard light-emission region may be illuminated. The spectral characteristic of the light from the direct W-LED backlight has a broader emission spectrum distribution than the spectral characteristic of the synthesized light of the direct RGB-LED, and therefore image display producing less deviation in the perceived color from user to user can be realized when the light from the direct W-LED backlight is used than when the synthesized light is used.

As described above, in this embodiment, similarly to the first and second embodiments, an image that produces little deviation in the perceived color from user to user can be displayed as the reference patch, and therefore the reference patch can be used as a reference for measuring an individual visual characteristic. As a result, the individual visual characteristic can be measured with a high degree of precision.

Further, according to this embodiment, only LEDs are used as the light emitting elements, and therefore a reduction in power consumption can be achieved in comparison with the first embodiment.

### Fourth Embodiment

A display apparatus and a control method thereof according to a fourth embodiment of the present invention will now be described.

In the second embodiment, an example in which direct backlights are used as the first light source and the second light source was described. In this embodiment, an example in which edge-light-type backlights are used as the first light source and the second light source will be described.

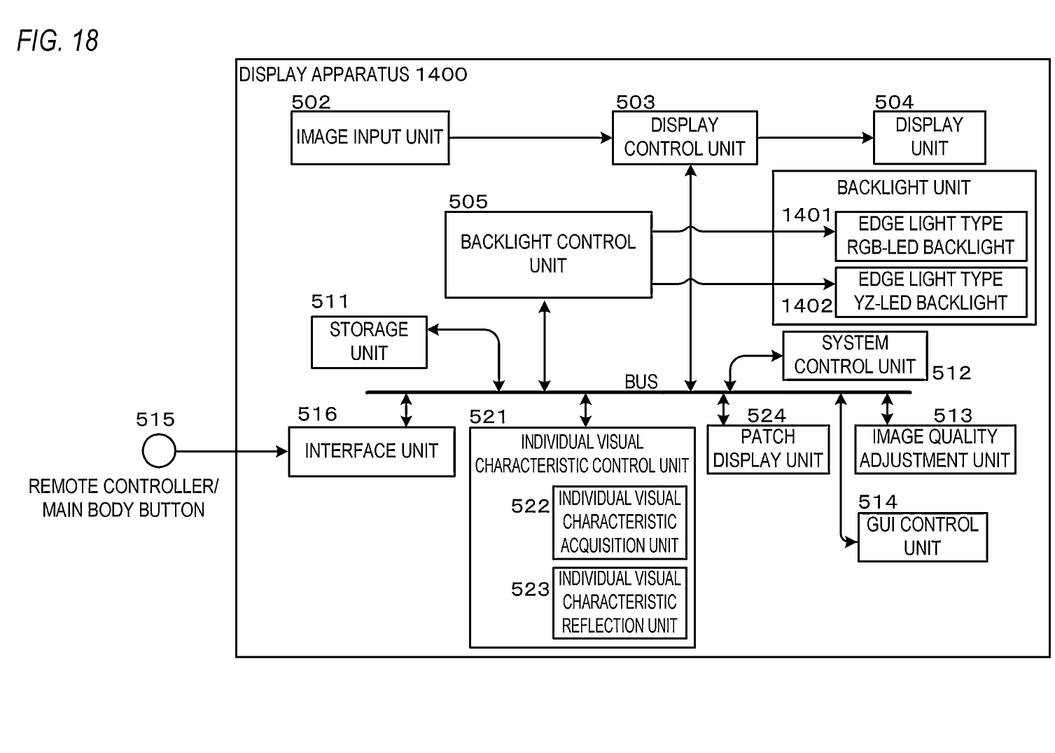

A configuration of the display apparatus according to the present invention will now be described using FIG. 18. FIG. 18 is a block diagram showing an example of the configuration of a display apparatus 1400 according to this embodiment. Identical function units with those of the second embodiment (FIG. 12) have been allocated identical reference numerals, and description thereof has been omitted.

As shown in FIG. 18, in this embodiment, the backlight unit includes an edge light type RGB-LED backlight 1401 (the first light source) and an edge light type YZ-LED backlight 1402 (the second light source).

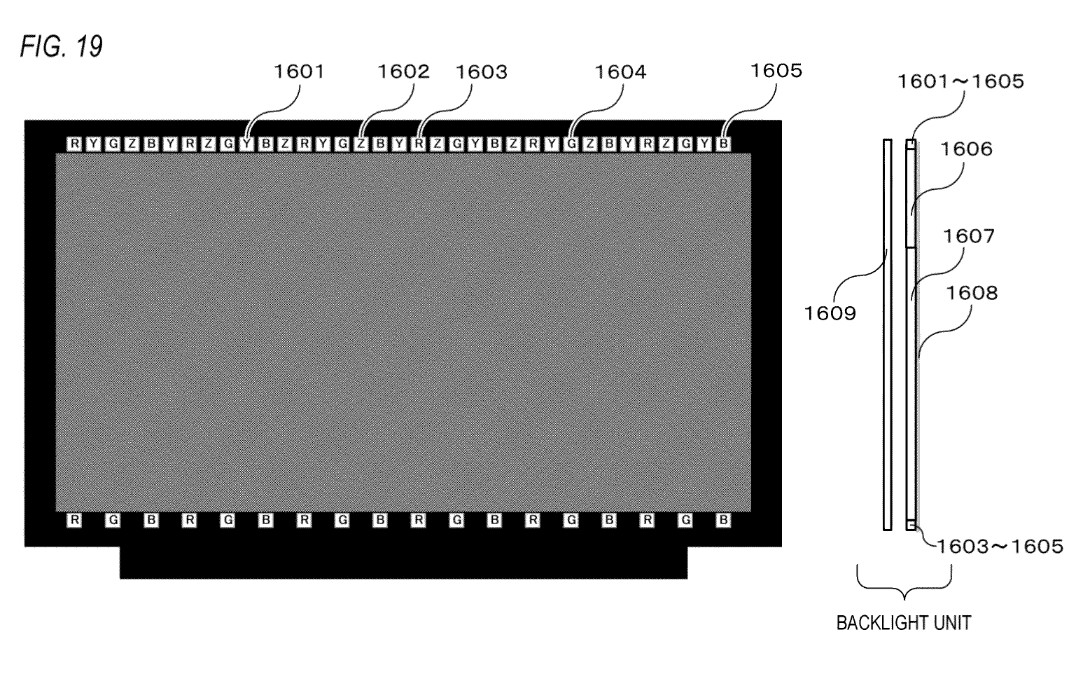

A structure of a light emission unit (the backlight unit) according to this embodiment will now be described using FIG. 19. FIG. 19 is a front view and a sectional view (a side view) showing the structure of the backlight unit according to this embodiment. In this embodiment, the backlight unit is configured to be capable of emitting the first light and the second light individually in a partial region of the screen.

As described above, the backlight unit includes the edge light type RGB-LED backlight 1401 and the edge light type YZ-LED backlight 1402.

The edge light type RGB-LED backlight 1401 is an edge light type backlight including a plurality of R-LEDs 1603, a plurality of G-LEDs 1604, and a plurality of B-LEDs 1605.

The edge light type YZ-LED backlight 1402 is an edge light type backlight including a plurality of Y-LEDs 1601 and a plurality of Z-LEDs 1602.

The backlight unit includes a light guiding plate 1606 having an exit surface region that matches the standard light emission region, and a light guiding plate 1607 having an exit surface region that matches the region obtained by subtracting the standard light emission region from the normal light emission region.

An entrance surface of the light guiding plate 1606 is disposed at the upper end of the screen. The Y-LEDs 1601, Z-LEDs 1602, R-LEDs 1603, G-LEDs 1604, and B-LEDs 1605 are likewise arranged at the upper end of the screen. Light from these LEDs enters the light guiding plate 1606 from the entrance surface of the light guiding plate 1606, undergoes repeated surface reflection, and then exits the light guiding plate 1606 from the exit surface of the light guiding plate 1606.

An entrance surface of the light guiding plate 1607 is disposed at a lower end of the screen. The R-LEDs 1603, G-LEDs 1604, and B-LEDs 1605 are likewise arranged at the lower end of the screen. Light from these LEDs enters the light guiding plate 1607 from the entrance surface of the light guiding plate 1607, undergoes repeated surface reflection, and then exits the light guiding plate 1607 from an exit surface of the light guiding plate 1607.

The light entering the light guiding plates is reflected and scattered by a reflective sheet 1608, for example.

The light exiting the light guiding plates is diffused by a diffusion sheet 1609. As a result, light having no brightness unevenness is emitted within the normal light emission region from the edge light type RGB-LED backlight 1401. Similarly, light having no brightness unevenness is emitted within the standard light emission region from the edge light type YZ-LED backlight 1402.

Here, the “light emitted from the edge light type RGB-LED backlight 1401” refers to the light that is emitted from the backlight unit when the R-LEDs 1603, G-LEDs 1604, and B-LEDs 1605 are driven. The “light emitted from the edge light type YZ-LED backlight 1402” refers to the light that is emitted from the backlight unit when the Y-LEDs 1601 and Z-LEDs 1602 are driven.

By employing the backlight unit configured as described above, image display can be performed in the standard light emission region using backlight light that produces a small amount of deviation in the perceived color from user to user. Hence, in this embodiment, by displaying the reference patch in the standard light emission region, the reference patch can be used as a reference when measuring an individual visual characteristic, and as a result, the individual visual characteristic can be measured with a high degree of precision. The principle by which backlight light that produces a small amount of deviation in the perceived color from user to user is obtained is similar to the second embodiment.

Note that in this embodiment, an example in which the light guiding plate 1606, which is shared by the edge light type RGB-LED backlight and the edge light type YZ-LED backlight, is used in relation to the standard light emission region was described, but the backlight unit is not limited to this configuration, and instead, for example, two light guiding plates, namely a light guiding plate entered by the light from the R-LEDs, G-LEDs, and B-LEDs and a light guiding plate entered by the light from the Y-LEDs and Z-LEDs, may be provided in relation to the standard light emission region. Further, it is not necessary to use two light guiding plates, namely a light guiding plate corresponding to the standard light emission region and a light guiding plate corresponding to the remaining region, as light guiding plates entered by the light from the R-LEDs, G-LEDs, and B-LEDs, and instead, a single light guiding plate having an exit surface region that matches the normal light emission region may be used as the light guiding plate entered by the light from the R-LEDs, G-LEDs, and B-LEDs.

A flow of processing performed by the display apparatus 1400 according to this embodiment is identical to that of the second embodiment (FIG. 7). In other words, in this embodiment, the light emission switch processing (the processing of S701 and S707) is performed in a similar manner to the second embodiment.

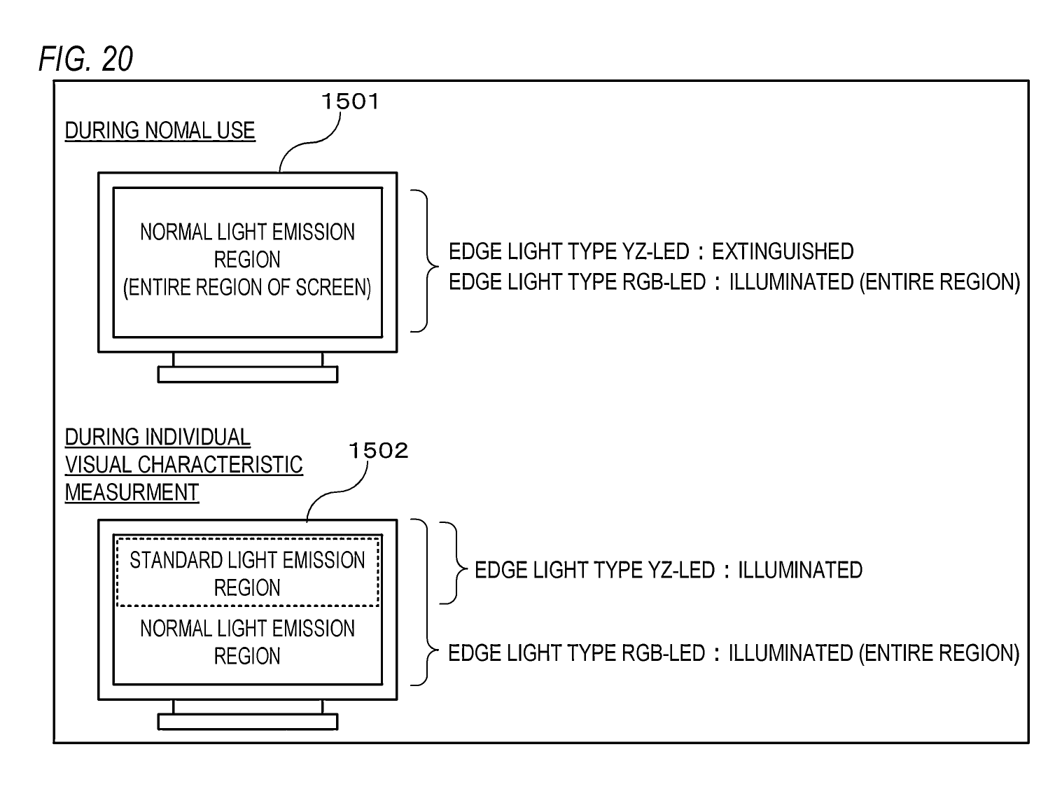

The light emission switch processing according to this embodiment will now be described using FIG. 20.

A reference numeral 1501 indicates the light-emission condition of the backlight unit during normal use of the monitor, for example during an image editing operation or a data conversion operation. During normal use, image display is performed by illuminating the edge light type RGB-LED backlight over the entire region (the normal light emission region) of the screen. More specifically, image display is performed by illuminating all of the R-LEDs, all of the G-LEDs, and all of the B-LEDs. At this time, the edge light type YZ-LED backlight is extinguished. More specifically, all of the Y-LEDs and all of the Z-LEDs are extinguished.

A reference numeral 1502 indicates the light emission condition of the backlight unit during individual visual characteristic measurement. During individual visual characteristic measurement, the edge light type RGB-LED backlight is illuminated over the entire normal light emission region, and the edge light type YZ-LED backlight is illuminated in the standard light emission region. Image display is then performed in this light emission condition. More specifically, image display is performed by illuminating all of the LEDs (all of the Y-LEDs, all of the Z-LEDs, all of the R-LEDs, all of the G-LEDs, and all of the B-LEDs). As a result, both the edge light type RGB-LED backlight and the edge light type YZ-LED backlight are illuminated in the standard light emission region, while only the edge light type RGB-LED backlight is illuminated in the remaining region (the region obtained by subtracting the standard light emission region from the normal light emission region).

In S701, the light emission condition of the backlight unit is switched from the light emission condition during normal use to the light emission condition during individual visual characteristic measurement, as described above. In S707, the light emission condition of the backlight is switched from the light emission condition during individual visual characteristic measurement to the light emission condition during normal use.

As described above, in this embodiment, similarly to the first to third embodiments, an image that produces little deviation in the perceived color from user to user can be displayed as the reference patch, and therefore the reference patch can be used as a reference when measuring an individual visual characteristic. As a result, the individual visual characteristic can be measured with a high degree of precision.

Further, according to this embodiment, only LEDs are used as the light emitting elements, and therefore a reduction in power consumption can be achieved in comparison with the first embodiment. Furthermore, a total number of LEDs can be reduced in comparison with the second and third embodiments, and therefore a reduction in power consumption can be achieved in comparison with the second embodiment.

### Fifth Embodiment

A display apparatus and a control method thereof according to a fifth embodiment of the present invention will now be described. In the fourth embodiment, the edge light type YZ-LED backlight is used as the second light source, but in this embodiment, an edge light type W-LED backlight is used as the second light source.

Note that only differences from the fourth embodiment will be described below, and description of configurations and so on that are identical with the fourth embodiment will be omitted.

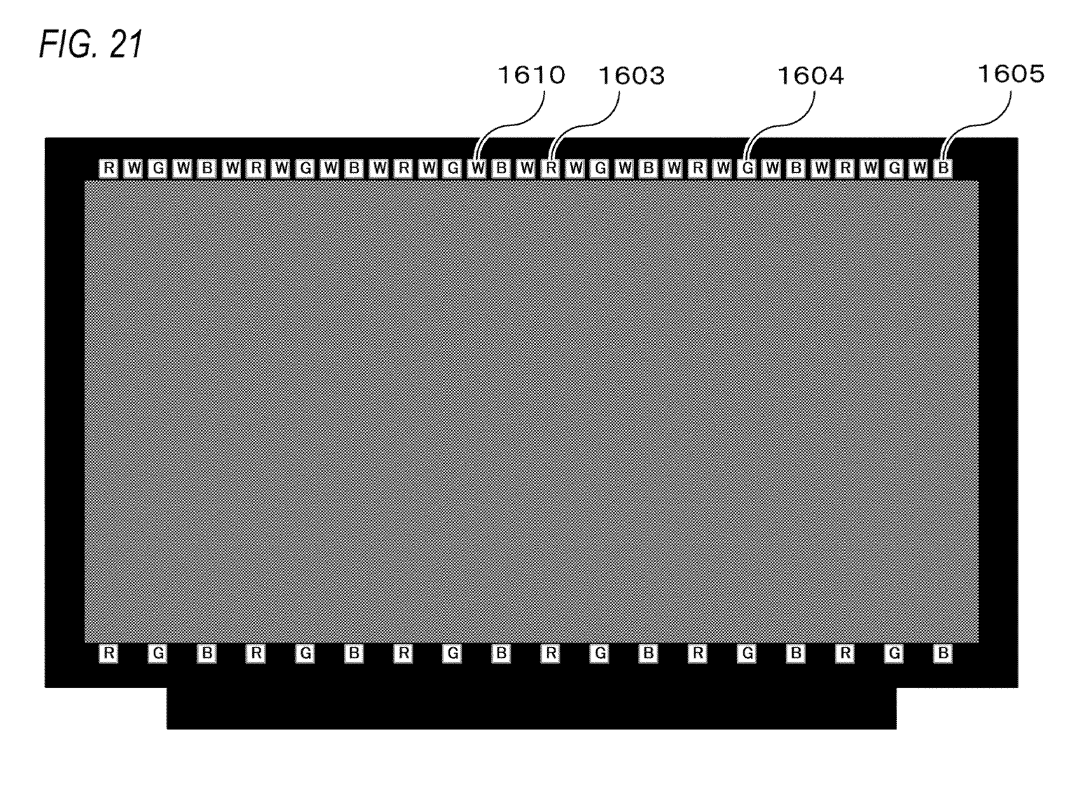

A structure of a light emission unit (the backlight unit) according to this embodiment will now be described using FIG. 21. FIG. 21 is a front view showing the structure of the backlight unit according to this embodiment. In this embodiment, the backlight unit is configured to be capable of emitting the first light and the second light individually in a partial region of the screen.

The backlight unit according to this embodiment includes an edge light type RGB-LED backlight (the first light source) and an edge light type W-LED backlight (the second light source). The edge light type W-LED backlight is an edge light type backlight including a plurality of W-LEDs 1610. The plurality of W-LEDs 1610 are arranged at the upper end of the screen. Light from the W-LEDs enters a light guiding plate having an exit surface region that matches the standard light emission region, and exits the light guiding plate from the exit surface of the light guiding plate.

The edge light type RGB-LED backlight is configured identically to the second embodiment, and therefore description thereof has been omitted.

By employing the backlight unit configured as described above, image display can be performed in the standard light emission region using backlight light that produces a small amount of deviation in the perceived color from user to user. Hence, in this embodiment, by displaying the reference patch in the standard light emission region, the reference patch can be used as a reference when measuring an individual visual characteristic, and as a result, the individual visual characteristic can be measured with a high degree of precision. The principle by which backlight light that produces a small amount of deviation in the perceived color from user to user is obtained is similar to the third embodiment.

In this embodiment, image display is performed during normal use by illuminating the edge light type RGB-LED backlight over the entire region (the normal light emission region) of the screen. At this time, the edge light type W-LED backlight is extinguished.

When measuring an individual visual characteristic, the edge light type RGB-LED backlight is illuminated over the entire normal light emission region, and the edge light type W-LED backlight is illuminated in the standard light emission region. Image display is then performed in this light emission condition. As a result, both the edge light type RGB-LED backlight and the edge light type W-LED backlight are illuminated in the standard light emission region, while in the remaining region (the region obtained by subtracting the standard light emission region from the normal light emission region) only the edge light type RGB-LED backlight is illuminated.

Note that during individual visual characteristic measurement, the edge light type W-LED backlight alone may be illuminated in the standard light emission region and the edge light type RGB-LED backlight alone may be illuminated in the remaining region. In other words, during individual visual characteristic measurement, the W-LEDs provided on the light guiding plate having an exit surface region that matches the standard light emission region may be illuminated while the R-LEDs, G-LEDs, and B-LEDs provided on the light guiding plate having an exit surface region that matches the standard light-emission region are extinguished. Meanwhile, the R-LEDs, G-LEDs, and B-LEDs provided on the light guiding plate having an exit surface region that matches the region obtained by subtracting the standard light emission region from the normal light emission region may be illuminated. The spectral characteristic of the light from the edge light type W-LED backlight has a broader emission spectrum distribution than a spectral characteristic of synthesized light obtained by synthesizing the light from the edge light type W-LED backlight and the light from the edge light type RGB-LED backlight. Therefore, an image display producing less deviation in the perceived color from user to user can be realized when the light from the edge light type W-LED backlight is used than when such synthesized light is used.

As described above, in this embodiment, similarly to the first to fourth embodiments, an image that produces little deviation in the perceived color from user to user can be displayed as the reference patch, and therefore the reference patch can be used as a reference when measuring an individual visual characteristic. As a result, the individual visual characteristic can be measured with a high degree of precision.

Further, according to this embodiment, only LEDs are used as the light emitting elements, and therefore a reduction in power consumption can be achieved in comparison with the first embodiment. Furthermore, the total number of LEDs can be reduced in comparison with the second and third embodiments, and therefore a reduction in power consumption can be achieved in comparison with the second embodiment.

### Sixth Embodiment

A display apparatus and a control method thereof according to a sixth embodiment of the present invention will now be described. In the first to fifth embodiments, examples in which the control and so on for obtaining the individual visual characteristic is performed by the display apparatus were described. In this embodiment, an example in which the control and so on for obtaining the individual visual characteristic is performed by a different external apparatus to the display apparatus will be described.

Note that in this embodiment, an example in which a display control apparatus that controls display by the display apparatus is used as the external apparatus will be described. The display control apparatus is a personal computer (PC), for example.

Also note that in this embodiment, an example in which the display apparatus uses the backlight unit of the first embodiment will be described, but the display apparatus may use one of the backlight unit structures described in the second to fifth embodiments instead.

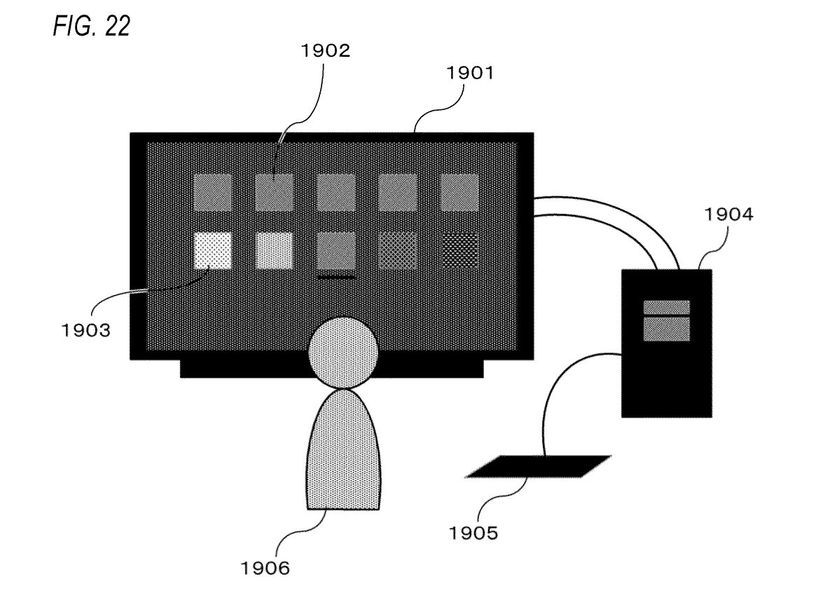

A method of measuring an individual visual characteristic using the display apparatus according to this embodiment will now be described broadly using FIG. 22.

A reference numeral 1901 denotes the display apparatus (a monitor) according to this embodiment.

A reference numeral 1904 denotes the display control apparatus that controls display by the display apparatus.

The display apparatus 1901 and the display control apparatus 1904 are connected to each other either wirelessly or by wire. For example, the display apparatus 1901 and the display control apparatus 1904 are connected to each other using an image data wire for transmitting image data and a control signal wire for transmitting control signals.

During individual visual characteristic measurement, the display control apparatus 1904 controls display by the display apparatus 1901 so that a reference patch 1902 and a measurement patch 1903 are displayed on a screen of the display apparatus 1901.

A reference numeral 1906 denotes an individual visual characteristic measurement subject who is a user. The user 1906 compares the reference patch 1902 and the measurement patch 1903 displayed on the monitor 1901, and inputs a comparison result into the display control apparatus 1904. The comparison result is input using an input device 1905 (a keyboard or a mouse) for use with the display control apparatus 1904, for example.

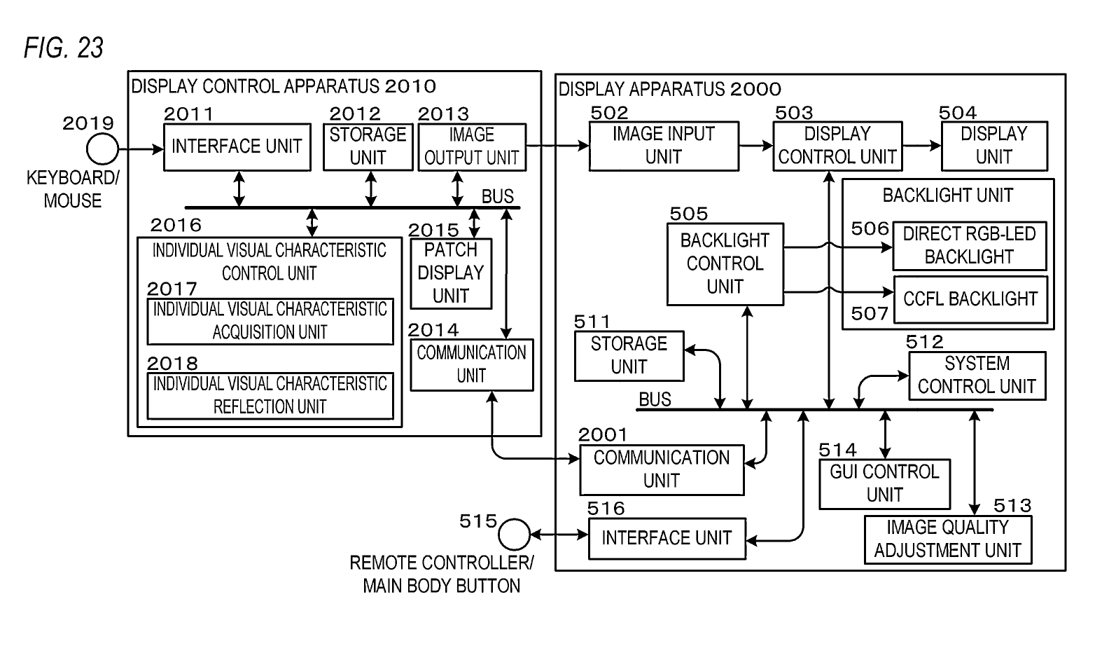

Configurations of the display apparatus and the display control apparatus according to this embodiment will now be described using FIG. 23. FIG. 23 is a block diagram showing an example of the configurations of the display apparatus and the display control apparatus according to this embodiment. Identical function units to the first embodiment (FIG. 5) have been allocated identical reference numerals, and description thereof has been omitted.

First, a display apparatus 2000 will be described.

The display apparatus 2000 displays image data output from a display control apparatus 2010. More specifically, the image data output from the display control apparatus 2010 is input into the image input unit 502, and then output to the display control unit 503. Display image data are then generated and displayed. However, in this embodiment, the synthesis processing for synthesizing the patch image data is not performed in the display apparatus 2000 (the display control unit 503). During individual visual characteristic measurement, image data indicating a patch image are output from the display control apparatus 2010.

A communication unit 2001 communicates with the external apparatus (the display control apparatus 2010). Operations of the respective function units of the display apparatus 2000 are controlled in accordance with control signals (control signals output from the external apparatus) input into the communication unit 2001. For example, the backlight control unit 505 performs the light emission switch processing in response to an instruction from the display control apparatus 2010. Similarly to the first to fifth embodiments, the light emission switch processing is performed at the start and the end of individual visual characteristic measurement (S701 and S707 in FIG. 7).

The display control apparatus 2010 will now be described.

An interface unit 2011 obtains an operation signal indicating a user operation performed using an input device 2019 such as a keyboard or a mouse.

A storage unit 2012 is a storage medium storing individual visual characteristic measurement results and the like.

An image output unit 2013 outputs image data to the display apparatus 2000. During normal use of the display apparatus 2000, the image output unit 2013 outputs normal image data. For example, image data selected by the user from among a plurality of image data recorded in advance in the storage unit 2012 are output as the normal image data. Further, image data obtained in response to a user operation on the Internet or the like are output as the normal image data. During individual visual characteristic measurement, the image output unit 2013 outputs patch image data generated by a patch display unit 2015, to be described below. Synthesized image data obtained by synthesizing the patch image data with the normal image data may also be output.

A communication unit 2014 communicates with the display apparatus 2000 (the communication unit 2001).

The patch display unit 2015 generates the patch image data (the image data of the measurement patch and the reference patch) in a similar manner to the patch display unit 524 according to the first embodiment.

An individual visual characteristic control unit 2016 includes an individual visual characteristic acquisition unit 2017 and an individual visual characteristic reflection unit 2018.

The individual visual characteristic acquisition unit 2017, similarly to the individual visual characteristic acquisition unit 522 of the first embodiment, performs various types of control for measuring an individual visual characteristic in response to a user operation. For example, the individual visual characteristic acquisition unit 2017 performs display control to display the measurement patch (the first image) and the reference patch (the second image) in order to measure an individual visual characteristic. More specifically, the individual visual characteristic acquisition unit 2017 instructs the patch display unit 2015 to set patch colors, sizes, display positions, and so on of the measurement patch and the reference patch, and to generate the patch image data. As a result, the patch image data are generated by the patch display unit 2015, whereupon the measurement patch and the reference patch are displayed on the display apparatus 2000. The processing described above relating to the patch display unit 2015 is started when a user operation to start measuring an individual visual characteristic is performed using the input device 2019.

Further, the individual visual characteristic acquisition unit 2017 obtains a perception result by the user in relation to the measurement patch and the reference patch displayed on the screen in response to a user operation performed using the input device 2019. More specifically, the individual visual characteristic acquisition unit 2017, similarly to the individual visual characteristic acquisition unit 522 according to the first embodiment, obtains the selection information indicating the measurement patch selected by the user. The individual visual characteristic acquisition unit 2017 then calculates the individual visual characteristic on the basis of the obtained measurement result, and records individual visual characteristic data indicating the calculated individual visual characteristic in the storage unit 2012.

The individual visual characteristic reflection unit 2018, similarly to the individual visual characteristic reflection unit 523 according to the first embodiment, reflects the individual visual characteristic obtained (calculated) by the individual visual characteristic acquisition unit 2017 in the image quality of the display apparatus 2000. More specifically, the individual visual characteristic reflection unit 2018 corrects a parameter (an image quality parameter) relating to the image quality of the monitor on the basis of the individual visual characteristic. In this embodiment, the correction value for correcting the parameter used in the image quality adjustment processing executed by the image quality adjustment unit 513 is determined on the basis of the individual visual characteristic, and the determined correction value is output to the image quality adjustment unit 513 via the communication units 2014, 2001. Accordingly, in the image quality adjustment unit 513, the parameter is corrected by the correction value, and the image quality adjustment processing is performed using the corrected parameter. As a result, image display can be performed at an image quality reflecting the individual visual characteristic.

A flow of an operation performed in a display system (a system including the display apparatus and the display control apparatus) according to this embodiment is similar to the flow (FIG. 7) of the operation performed by the display apparatus according to the first embodiment, and therefore description thereof has been omitted.

As described above, in this embodiment, the light from the backlight unit is controlled in a similar manner to the first to fifth embodiments using the display apparatus and the external apparatus. Hence, similarly to the first to fifth embodiments, an image that produces little deviation in the perceived color from user to user can be displayed as the reference patch, and therefore the reference patch can be used as a reference when measuring an individual visual characteristic. As a result, the individual visual characteristic can be measured with a high degree of precision.

### Seventh Embodiment

A display apparatus and a control method thereof according to a seventh embodiment of the present invention will now be described.

As a result of temporal variation in the display or variation in the individual visual characteristic following measurement of the individual visual characteristic and correction of the image quality parameter, the image quality adjustment processing based on the individual visual characteristic may become inappropriate for the observer. Furthermore, the user does not know when the individual visual characteristic should be re-measured. As a result, the user may perform an operation without noticing that the image quality adjustment processing based on the individual visual characteristic is incorrect.

Hence, in the seventh embodiment, an example in which the reference image (the reference patch) and a verification image (a verification patch) are displayed in a normal use mode will be described. The reference image and the verification image are displayed in a part of the screen. The reference image is an image that has not been subjected to the image quality adjustment processing based on the individual visual characteristic, while the verification image is an image obtained by subjecting the reference image to the image quality adjustment processing based on the individual visual characteristic. The user can determine whether or not the image quality adjustment processing based on the individual visual characteristic is correct by determining whether or not the reference image matches the verification image. As a result, the user can learn the timing at which the individual visual characteristic is to be re-measured, and the individual visual characteristic can be re-measured at an appropriate timing.

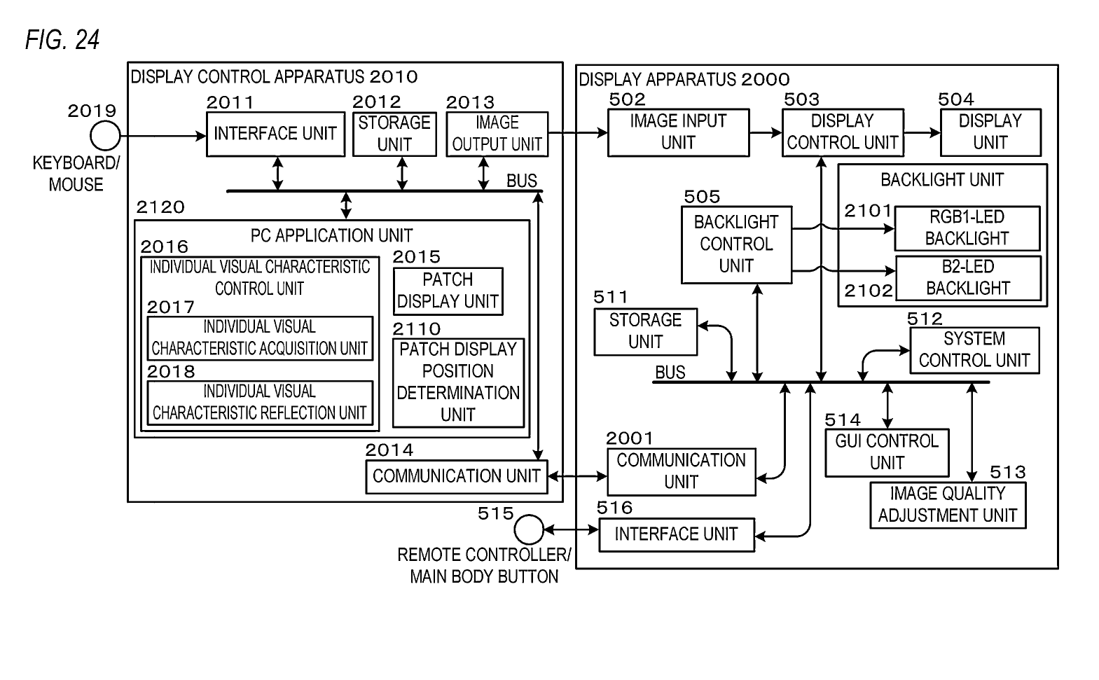

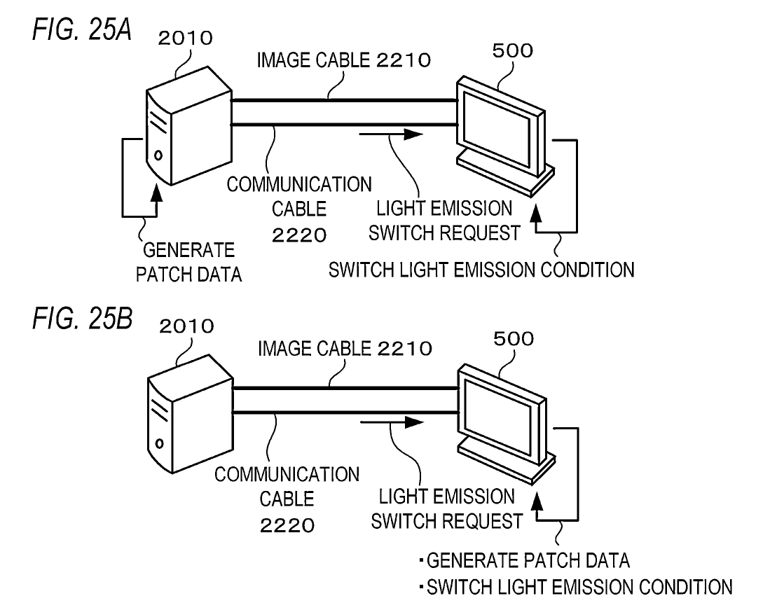

A configuration of a system according to this embodiment will now be described broadly using FIG. 25A. As shown in FIG. 25A, the system according to this embodiment includes the display apparatus 500 and a PC 2010 (a personal computer). The PC 2010 serves as the display control apparatus.

As shown in FIG. 25A, the display apparatus 500 is connected to the PC 2010 using an image cable 2210. The display apparatus 500 is also connected to the PC 2010 using a communication cable 2220. The image cable 2210 is used to transmit image data. The communication cable 2220 is used to transmit data (non-image data) other than image data. A PC application such as color editing software is installed in the PC 2010. The color editing software may be video editing software, graphics software, viewer software, and so on, for example. When the PC application is executed on the PC 2010, image data for the reference patch (reference patch data) and image data for a pre-verification patch (pre-verification patch data) are generated. As will be described in detail below, the pre-verification patch is a patch serving as a source of the verification patch. A light emission switch request to switch the light emission condition of the backlight provided in the display apparatus 500 is transmitted from the PC 2010 to the display apparatus 500. The light emission condition of the backlight is switched in response to the light emission switch request, whereupon the patch data generated by the PC 2010 are displayed. At this time, display positions of the reference patch and the verification patch are transmitted from the PC 2010 to the display apparatus 500.

Note that the display control apparatus is not limited to a PC.

Also note that the image data and the non-image data may be transmitted using an identical cable. In other words, the display apparatus 500 and the PC 2010 may be connected to each other using only one cable. The display apparatus 500 and the PC 2010 may also be connected to each other wirelessly.

Configurations of the display control apparatus and the display apparatus according to this embodiment will now be described using FIG. 24. FIG. 24 is a block diagram showing an example of the configurations of the display apparatus and the display control apparatus according to this embodiment. Note that identical function units with the first to sixth embodiments have been allocated identical reference numerals, and description thereof has been omitted.

A PC application unit 2120 is a function unit realized by executing the PC application installed in the display control apparatus 2010. The PC application unit 2120 measures the individual visual characteristic, determines the patch display positions, and displays the patches. The PC application unit 2120 includes the individual visual characteristic control unit 2016, the patch display unit 2015, and a patch display position determination unit 2110.

The backlight unit includes an RGB1-LED backlight 2101 serving as the first light source, and a B2-LED backlight 2102 serving as the second light source. The backlight control unit 505 causes the backlight unit to emit light at the target brightness determined by the image quality adjustment unit 513. In other words, the backlight control unit 505 controls the emission brightness of the RGB1-LED backlight 2101 and the B2-LED backlight 2102 on the basis of the target brightness determined by the image quality adjustment unit 513. Further, the backlight control unit 505 performs the light emission switch processing for switching the light emission conditions of the RGB1-LED backlight 2101 and the B2-LED backlight 2102 in response to a request (a light emission switch request) from the individual visual characteristic control unit 521. The RGB1-LED backlight 2101 and the B2-LED backlight 2102 are light emission modules that irradiate the back surface of the display unit 504 (a liquid crystal panel) with light.

The patch display position determination unit 2110 determines the display positions of the reference patch and the verification patch. The patch display position determination unit 2110 determines the display positions in consideration of a working area of the user so that the patches are displayed in a region that does not obstruct work.

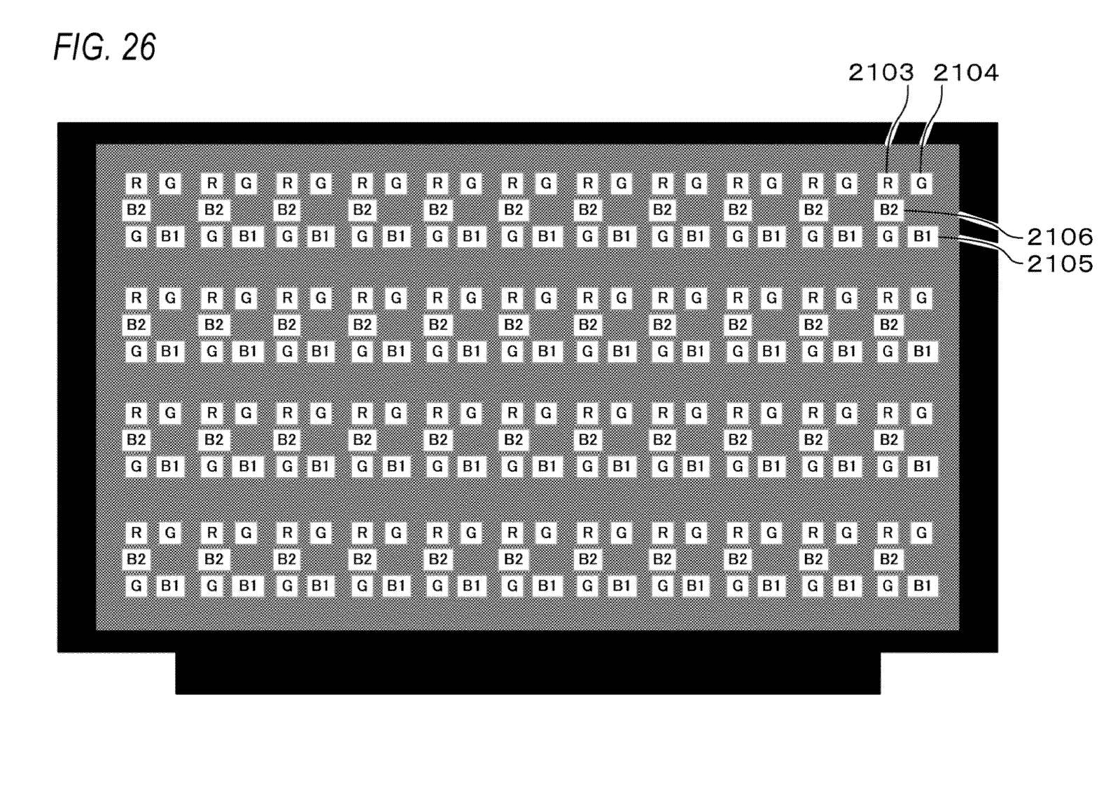

A structure of the backlight unit according to this embodiment will now be described using FIG. 26. FIG. 26 is a front view showing the structure of the backlight unit according to this embodiment.

As shown in FIG. 26, the RGB1-LED backlight 2101 is a direct backlight including red LEDs 2103, green LEDs 2104, and first blue LEDs 2105 (first blue LEDs B1).

Further, as shown in FIG. 26, the B2-LED backlight 2102 is a direct backlight including second blue LEDs 2106 (second blue LEDs B2).

In this embodiment, as shown in FIG. 26, a single LED group is constituted by four LEDs, namely a red LED 2103, a green LED 2104, a first blue LED 2105, and a second blue LED 2106. A plurality of the LED groups are arranged at equal intervals over the entire screen.

It is known that a degree of difference in the appearance of a color due to a difference in the individual visual characteristic varies from color to color. More specifically, it is known that the greatest difference in the appearance of a color due to a difference in the individual visual characteristic occurs in a blue color wavelength. In this embodiment, therefore, as shown in FIG. 26, individual visual characteristics are measured using two blue light emitting diodes B-LED having different spectral characteristics. As will be described in detail below, by illuminating the two blue light emitting diodes B-LED having different spectral characteristics, differences in the appearance of a color due to a difference in the individual visual characteristic can be reduced.

In this embodiment, light from the RGB1-LED backlight 2101 is used as the first light. The verification patch is displayed in a condition where the B2-LED backlight 2102 is extinguished and the RGB1-LED backlight 2101 is illuminated. In other words, in a verification display region for displaying the verification patch, the B2-LED backlight 2102 is extinguished and the RGB1-LED backlight 2101 is illuminated.

Further, synthesized light obtained by synthesizing the light from the RGB1-LED backlight 2101 and light from the B2-LED backlight 2102 is used as the second light. The reference patch is displayed by illuminating both the RGB1-LED backlight 2101 and the B2-LED backlight 2102. In other words, in a reference display region for displaying the reference patch, both the RGB1-LED backlight 2101 and the B2-LED backlight 2102 are illuminated.

Hereafter, the blue light emitting diodes (the blue LEDs 2105) provided in the RGB1-LED backlight 2101 will be referred to as “B1-LEDs”, and the blue light emitting diodes (the blue LEDs 2106) provided in the B2-LED backlight 2102 will be referred to as “B2-LEDs”.

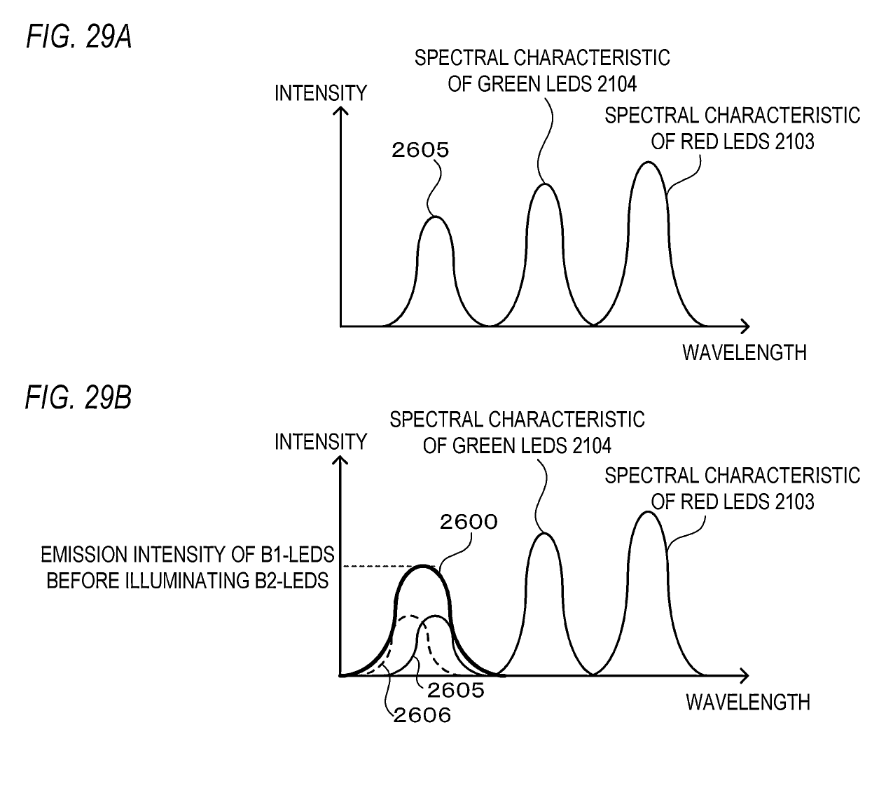

FIGS. 29A and 29B show an example of the spectral characteristics of the B1-LEDs 2105 and the B2-LEDs 2106. FIGS. 29A and 29B also shows spectral characteristics of the red LEDs 2103 and the green LEDs 2104. A reference numeral 2605 denotes the spectral characteristic of the B1-LEDs 2105, and a reference numeral 2606 denotes the spectral characteristic of the B2-LEDs 2106. In the example of FIGS. 29A and 29B, the spectral characteristic 2606 of the B2-LEDs 2106 has a wavelength peak on a short wavelength side of a wavelength peak of the spectral characteristic 2605 of the B1-LEDs 2105. A reference numeral 2600 denotes a spectral characteristic (a synthesized spectral characteristic) of the synthesized light obtained when both the B1-LEDs 2105 and the B2-LEDs 2106 are illuminated. A full width at half maximum of the synthesized spectral characteristic 2600 is broader than a full width at half maximum of the spectral characteristic of the B1-LEDs 2105. This means that under the synthesized light obtained when both the B1-LEDs 2105 and the B2-LEDs 2106 are illuminated, the difference in the appearance of a color due to a difference in the individual visual characteristic is smaller than under the light from the B1-LEDs 2105. In this embodiment, this characteristic is used to measure the individual visual characteristic.

The backlight unit according to this embodiment is structured as described above.

In this embodiment, as described above, the plurality of LED groups (the LED groups respectively constituted by four LEDs, namely the red LED 2103, the green LED 2104, the blue LED 2105, and the blue LED 2106) are arranged over the entire screen. In this embodiment, therefore, the backlight unit can emit the first light and the second light individually over the entire region of the screen.

Note that in this embodiment, a direct backlight is used, but an edge light type backlight may be used instead of the RGB1-LED backlight 2101. An edge light type backlight may also be used instead of the B2-LED backlight 2102. The backlight units described in the other embodiments may also be used as the backlight unit.

The spectral characteristic of the B2-LEDs 2106 may have a wavelength peak on a long wavelength side of the wavelength peak of the spectral characteristic of the B1-LEDs 2105.

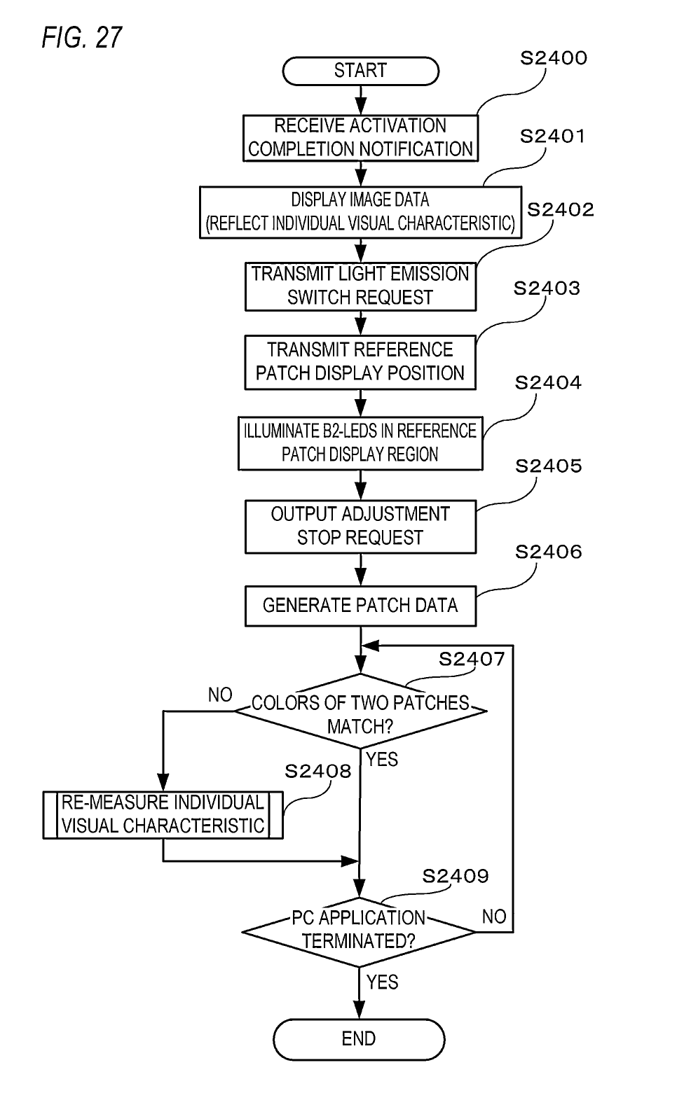

An example of a flow of processing performed in the system according to this embodiment will now be described using FIG. 27. FIG. 27 is a flowchart showing an example of a processing flow from display of the reference patch and the verification patch, with which an application condition of the individual visual characteristic can be checked, to re-measurement of the individual visual characteristic.

In S2400, the system control unit 512 receives an activation completion notification indicating that activation of the PC application is complete from the display control apparatus 2010. In this embodiment, display of the reference patch and the verification patch is started upon activation of the PC application. The reference patch and the verification patch are displayed until the PC application is terminated.

In S2401, image data output from the display control apparatus 2010 to the display apparatus 500 is displayed after being subjected to image quality adjustment processing on the basis of a measured individual visual characteristic. More specifically, the system control unit 512 issues a request to the individual visual characteristic reflection unit 523 to reflect the individual visual characteristic. To reflect the individual visual characteristic obtained by the individual visual characteristic acquisition unit 522 in the image quality of the display apparatus 500, the individual visual characteristic reflection unit 523 performs processing to obtain image quality information relating to the monitor and processing to calculate the correction value used in the image quality adjustment processing based on the individual visual characteristic. The individual visual characteristic reflection unit 523 outputs the calculated correction value to the image quality adjustment unit 513. The image quality adjustment unit 513 applies image quality adjustment processing using the correction value to the image data input into the display apparatus 500. The display unit 504 then displays the image data subjected to the image quality adjustment processing. At this time, the operating mode of the display apparatus 500 is the normal use mode. Accordingly, the backlight unit emits the first light over the entire region of the screen.

In S2401, the image quality adjustment processing based on the measured individual visual characteristic is applied to an entire region of an image expressing the image data input into the display apparatus 500. As a result, an image having an image quality that reflects the individual visual characteristic can be displayed in the normal use mode following measurement of the individual visual characteristic. In other words, display that enables the user to perceive colors correctly can be performed. In this embodiment, the PC application is an image editing (color editing and so on) application, and image data representing an image on which a main image serving as an editing subject image is disposed are input into the display apparatus 500. By performing the processing of S2401, the user can perceive the colors of the editing subject main image accurately. Hereafter, an image in which the main image has been subjected to the image quality adjustment processing based on the measured individual visual characteristic will be referred to as a “main display image”.

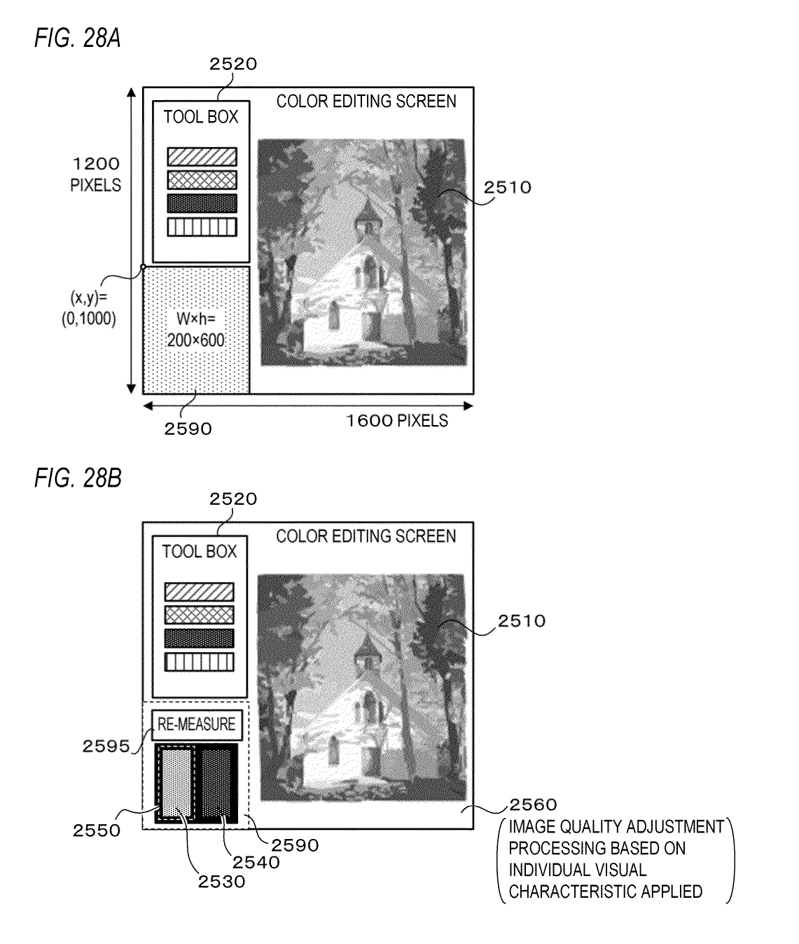

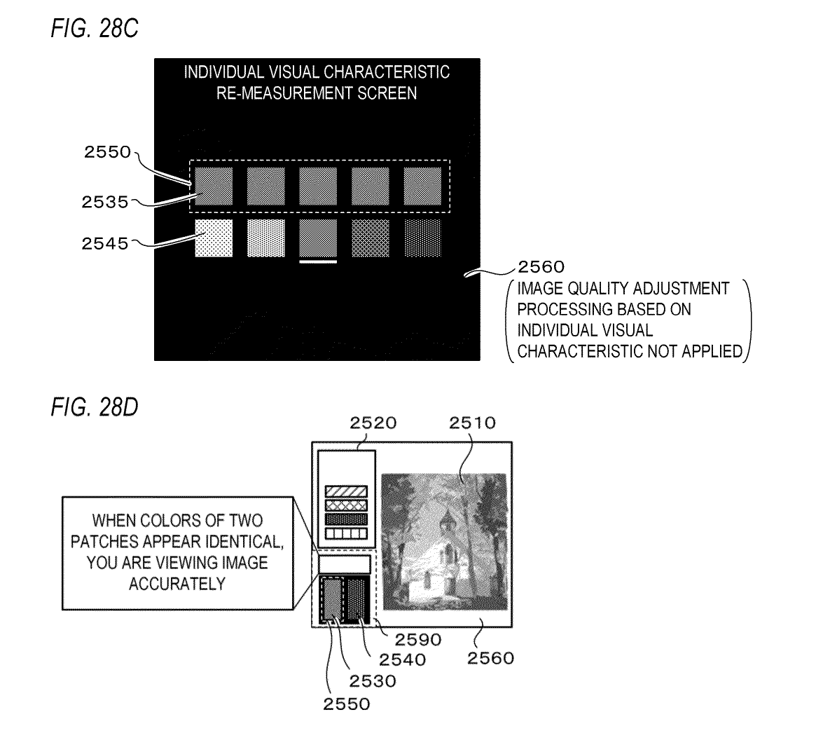

By performing the processing described above in S2401, the user can perform an editing operation while perceiving colors accurately in accordance with the individual visual characteristic, for example. FIG. 28A is a view showing an example of a display image (an image displayed on the screen) during the editing operation. A reference numeral 2510 denotes the main display image, and a reference numeral 2520 denotes a toolbox used for color editing.

In S2402, the display control apparatus 2010 instructs the display apparatus 500 to display the reference patch and the verification patch. More specifically, the patch display unit 2015 of the display control apparatus 2010 transmits a light emission switch request to the system control unit 512 of the display apparatus 500 via the communication unit 2014. Upon reception of the light emission switch request, the system control unit 512 transmits a response indicating that the light emission switch request has been received to the display control apparatus 2010.

In S2403, the patch display position determination unit 2110 transmits the position of the region in which light emission by the backlight unit is to be switched to the system control unit 512 of the display apparatus 500. In other words, the patch display position determination unit 2110 transmits the display position of the reference patch. The system control unit 512 then notifies the backlight control unit 505 of the display position of the reference patch. The patch display position determination unit 2110 determines the patch display positions so that the patches are displayed in a region that does not obstruct the editing operation performed by the user. In FIG. 28A, a region outside the regions of the main display image 2510 and the toolbox 2520 serves as the region that does not obstruct the editing operation. For example, a blank region 2590 is used as the region that does not obstruct the editing operation. In FIG. 28A, the overall size of the image is 1200 pixels in a horizontal direction×1600 pixels in a vertical direction. The blank region 2590 is a region having a horizontal direction coordinate x=0, a vertical direction coordinate y=1000, a width w (a horizontal direction size)=200 pixels, and a height h (a vertical direction size)=600 pixels. The patch display position determination unit 2110 determines the display positions of the reference patch and the verification patch so that the reference patch and the verification patch are displayed inside the blank region 2590. When an arrangement of the main display image 2510 and the toolbox 2520 is modified, the blank region 2590 may vary. When the blank region 2590 varies, the display positions of the reference patch and the verification patch also vary. Hence, when the arrangement of the main display image 2510 and the toolbox 2520 is modified, the processing for determining the display positions of the reference patch and the verification patch is performed again, for example. Alternatively, variation of the blank region 2590 is detected, and the processing for determining the di splay positions of the reference patch and the verification patch is performed again in response to variation of the blank region 2590.

In S2404, the backlight control unit 505 illuminates the B2-LED backlight in a display region of the reference patch (the region in which the reference patch is displayed). As a result, the RGB1-LED backlight and the B2-LED backlight are both illuminated in the display region of the reference patch. In other words, the second light is emitted from the backlight unit in the display region of the reference patch. Here, the backlight control unit 505 performs processing to reduce the emission brightness of the B1-LEDs in the display region of the reference patch so that the emission brightness before and after illumination of the B2-LED backlight takes an identical value.

A spectral characteristic 2605 shown in FIG. 29A is an example of the spectral characteristic of the B1-LEDs prior to illumination of the B2-LEDs. A spectral characteristic S605 shown in FIG. 29B is an example of the spectral characteristic of the B1-LEDs following illumination of the B2-LEDs. It is evident from FIGS. 29A and 29B that an optical intensity (the height of the wavelength peak) of the spectral characteristic 2605 of the B1-LEDs is lower following illumination of the B2-LEDs than prior to illumination of the B2-LEDs. It is also evident that the optical intensity of the synthesized spectral characteristic 2600, shown in FIG. 29B, substantially matches the optical intensity of the spectral characteristic 2605 (the spectral characteristic of the B1-LEDs) prior to illumination of the B2-LEDs. The method of adjusting the emission brightness using the brightness sensor is identical to the first embodiment, and therefore description thereof has been omitted.

In this embodiment, by illuminating both the B1-LEDs and the B2-LEDs, the synthesized spectral characteristic 2600 having a broad full width at half maximum is obtained as a blue spectral characteristic. As a result, differences in the appearance of a color due to a difference in the individual visual characteristic can be reduced in comparison with a case where the B2-LEDs are not illuminated. Using this mechanism, the application condition of the individual visual characteristic can be checked.

The timing at which to re-measure the individual visual characteristic can be determined as long as the first light is emitted in the region including at least the display region of the verification patch and the second light is emitted in the region including at least the display region of the reference patch. Hence, the first light may be emitted only in the display region of the verification patch, and the second light may be emitted over a wider region than the display region of the reference patch.

In S2405, the individual visual characteristic reflection unit 523 of the display control apparatus 2010 outputs an adjustment stop request to the system control unit 512 to stop the image quality adjustment processing (the image quality adjustment processing based on the measured individual visual characteristic) in the display region of the reference patch. The system control unit 512 outputs the input adjustment stop request to the image quality adjustment unit 513. As a result, the image quality adjustment processing is no longer applied to the display region of the reference patch. In other words, the image quality adjustment processing is applied only to a region other than the display region of the reference patch.

In S2406, the patch display unit 2015 generates the reference patch data and the pre-verification patch data in accordance with the display positions of the reference patch and the verification patch determined by the patch display position determination unit 2110. The pre-verification patch data are intermediate data on which image quality adjustment processing is to be applied subsequently by the image quality adjustment unit 513 of the display apparatus 2000. In the display control apparatus 2010, a pixel value of the pre-verification patch data is equal to a pixel value of the reference patch data. The pixel value of the pre-verification patch data and the reference patch data is equal to a gray pixel value (R value=G value=B value=128), for example. Image data representing an image on which the reference patch and a pre-verification patch (an image expressing the pre-verification patch data; an identical image to the reference patch) are then output from the display control apparatus 2010. The pre-verification patch alone is then subjected to image quality adjustment processing by the image quality adjustment unit 513 of the display apparatus 2000, whereupon a result based on the individual visual characteristic is reflected therein. As a result, the reference patch is displayed without undergoing the image quality adjustment processing, while the pre-verification patch is displayed after being converted into the verification patch by undergoing the image quality adjustment processing.

FIG. 28B is a view showing an example of a display image on which the patches are disposed. As a result of the processing of S2406, a reference patch 2530 and a verification patch 2540 are displayed in the blank region 2590. In the example of FIG. 28B, the verification patch 2540 is displayed in the vicinity of the reference patch 2530 (in a position removed from the reference patch 2530 by a predetermined distance). When the patch data have been generated, the patch display unit 2015 notifies the system control unit 512 that display of the patches is complete. In FIG. 28B, a reference numeral 2550 denotes the standard light emission region, and a reference numeral 2560 denotes the normal light emission region. In the example of FIG. 28B, the display region of the reference patch corresponds to the standard light emission region 2550, and a region other than the display region of the reference patch corresponds to the normal light emission region 2560.

In S2407, the user checks the reference patch and the verification patch, and confirms whether or not the application condition of the current individual visual characteristic is correct.

A method of checking the application condition will now be described. The user determines whether or not the color of the verification patch 2540 displayed using the first light appears to match the color of the reference patch 2530 displayed using the second light. When the colors of the two patches appear to match, it is determined that a correct individual visual characteristic is being applied (the image quality adjustment processing has been applied correctly), and the current flow is terminated. When the two colors appear not to match, on the other hand, it is determined that an incorrect individual visual characteristic is being applied, and therefore the processing advances to S2408. Having determined that an incorrect individual visual characteristic is being applied, the user selects a re-measure button 2595 shown in FIG. 28B using the mouse 2019, for example. When the re-measure button 2595 is selected, a result indicating that the colors of the patches do not match is transmitted to the system control unit 512 from the PC application unit 2120, whereupon the processing advances to S2408.

Since the reference patch 2530 is displayed using the second light, a difference in the appearance of the color of the reference patch 2530 due to a difference in the individual visual characteristic is small. Further, the verification patch 2540 is displayed so as to reflect the previous individual visual characteristic measurement result, and therefore, when the previous individual visual characteristic measurement result matches the current individual visual characteristic, the color of the reference patch 2530 and the color of the verification patch 2540 appear to be substantially identical. When the previous individual visual characteristic measurement result does not match the current individual visual characteristic, on the other hand, the color of the verification patch 2540 appears to be a different color to the color of the reference patch 2530. For example, the color of the verification patch 2540 may appear different to the color of the reference patch 2530 when the user changes, when the visual characteristic of the user varies over time, and so on. The color of the verification patch 2540 may also appear different to the color of the reference patch 2530 when a display characteristic of the display varies over time. When the color of the verification patch 2540 appears different to the color of the reference patch 2530, the individual visual characteristic must be re-measured.

In S2408, the individual visual characteristic is re-measured. The method of measuring the individual visual characteristic is identical to the first embodiment. The system control unit 512 controls the respective function units such that the individual visual characteristic is re-measured.

When the user presses the re-measure button 2595 shown in FIG. 28B, an individual visual characteristic re-measurement image is displayed, as shown in FIG. 28C. Reference patches 2535 and measurement patches 2545 are displayed using an identical method with that of the first embodiment.

When the individual visual characteristic is re-measured, the visual characteristic reflection unit 2018 outputs a request to stop executing the image quality adjustment processing based on the individual visual characteristic to the image quality adjustment unit 513 via the system control unit 512. As a result, execution of the image quality adjustment processing based on the individual visual characteristic is stopped.

Further, the visual characteristic reflection unit 2018 outputs a request to switch light emission by the backlight unit to the image display apparatus 500 via the communication unit 2014. As a result, the backlight control unit 505 extinguishes all of the B2-LEDs, and illuminates the RGB1-LED backlight over the entire region of the screen.

Accordingly, a black image is displayed so that the entire screen is black. Next, the backlight control unit 505 re-illuminates the B2-LEDs in a partial region of the screen. The region in which the B2-LEDs are illuminated (i.e. the region in which both the RGB1-LED backlight and the B2-LED backlight are illuminated) is used as the standard light emission region 2550. The region in which the B2-LEDs are not illuminated (i.e. the region in which only the RGB1-LED backlight is illuminated) is used as the normal light emission region 2560.

When the light emission condition has been switched, the patch display unit 2015 generates the patch data so that the reference patches 2535 are displayed in the standard light emission region 2550 and the measurement patches 2545 are displayed in the vicinity thereof (in the normal light emission region 2560). Since execution of the image quality adjustment processing based on the individual visual characteristic has been stopped, the patch data are displayed without undergoing the image quality adjustment processing based on the individual visual characteristic. In the example of FIG. 28C, five measurement patches 2545 having different pixel values are displayed. Further, five reference patches 2535 having equal pixel values are displayed. Processing for having the user select the measurement patch 2545 that appears closest in color to the color of the reference patch 2535 from among the five measurement patches 2545 is performed in relation to a plurality of pixel values (the pixel value of the reference patch). In so doing, the individual visual characteristic is re-measured, and as a result, a correction value (a correction value of the parameter used in the image quality adjustment processing) that corresponds to the current individual visual characteristic can be obtained.

When re-measurement of the individual visual characteristic is complete, the display is switched from the display shown in FIG. 28C to the display shown in FIG. 28B.

Finally, in S2409, a determination is made as to whether or not the PC application has been terminated. When the PC application is operative, the processing returns to S2407. When the PC application has been terminated, the reference patch data and the pre-verification patch data are deleted. The backlight control unit 505 then controls the light emission condition of the backlight unit so that the first light is emitted over the entire screen.

According to this embodiment, as described above, the reference patch and the verification patch, with which the application condition of the individual visual characteristic can be checked, are displayed in the normal use mode. Therefore, the user can perform a normal operation such as color editing while checking whether or not the applied individual visual characteristic is correct. Hence, when the display characteristic of the display or the individual visual characteristic of the user varies overtime, the user can be made aware of these characteristic variations while continuing normal operations. As a result, the individual visual characteristic can be re-measured at an appropriate timing. When the individual visual characteristic is re-measured, the user can perceive the colors of an image accurately.

Further, when the display is viewed by a plurality of people, it is possible to check whether or not each person can see the colors correctly. As shown in FIG. 28D, for example, when an image is observed by a plurality of people, a message image such as “When the colors of the two patches appear identical, you are viewing the image accurately” may be displayed in addition to the reference patch 2530 and the verification patch 2540. In so doing, it is possible to determine whether all of the users can see the colors of the image accurately, whether any users cannot see the colors of the image accurately, the identities of the users who can and cannot see the colors of the image accurately, and so on.

Note that FIGS. 28A, 28B and 28D show an example in which the patches are displayed in the blank region in a lower left part of the screen, but according to this embodiment, the backlight unit is capable of emitting the second light over the entire region of the screen, and therefore the patches may be displayed in an upper right part, a lower right part, an upper left part, a central part, or any other part of the screen.

In this embodiment, an example in which the patch data are generated by the PC (the PC application unit) was described. The present invention is not limited thereto, however, and instead, as shown in FIG. 25B, the display positions of the patches (or information indicating the blank region) may be transmitted from the PC to the display apparatus so that the patch data are generated in the display apparatus.

Further, in this embodiment, an example in which a single color patch is displayed was described, but the present invention is not limited thereto, and instead, for example, an image having a plurality of pixel values may be displayed as the patch. More specifically, an image having a gradation that varies from a pixel value A to a pixel value B may be displayed as the patch. Further, a graphic image such as an icon may be displayed instead of a patch. Accordingly, graphic image data may be used as the reference patch data, and identical graphic image data to the reference patch data may be used as the pre-verification patch data.

Furthermore, in this embodiment, an example in which a single reference patch and a single verification patch are displayed was described, but a plurality of reference patches and a plurality of verification patches corresponding to the plurality of reference patches may be displayed instead.

### Eighth Embodiment

A display apparatus and a control method thereof according to an eighth embodiment of the present invention will now be described.

In this embodiment, an example in which the pixel value of the reference patch (the pixel value of the pre-verification patch data) is determined on the basis of a pixel value of the main image will be described.

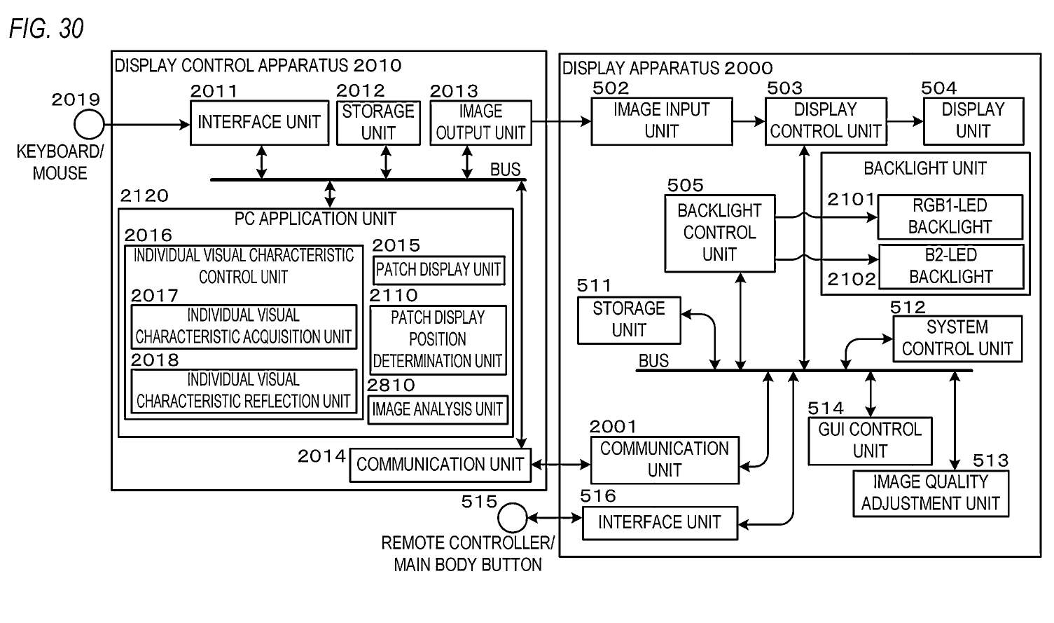

Configurations of the display control apparatus and the display apparatus according to this embodiment will now be described using FIG. 30. FIG. 30 is a block diagram showing an example of the configurations of the display control apparatus and the display apparatus according to this embodiment. Identical function units to the seventh embodiment have been allocated identical reference numerals, and description thereof has been omitted.

The PC application unit 2120 further includes an image analysis unit 2810. Note that the image analysis unit 2810 may be provided in the display apparatus 500.

In this embodiment, similarly to the seventh embodiment, the reference image (the reference patch), the verification image (the verification patch), and the main display image are displayed during normal image display. More specifically, the reference image (the reference patch), the verification image (the verification patch), and the main display image are displayed when the functions of the PC application unit 2120 are realized by executing the PC application. As described in the seventh embodiment, the main display image is an image obtained by applying the image quality adjustment processing (the image quality adjustment processing based on the measured individual visual characteristic) to the main image.

The image analysis unit 2810 analyzes the colors included in the main image to determine which of the colors included in the main image produces the most prominent difference in color appearance. The patch display unit 2015 generates the reference patch data, which are patch data representing the colors included in the main image, and the pre-verification patch data on the basis of the determination result obtained by the image analysis unit 2810. A reference patch of the colors included in the main image is then displayed by performing similar processing to the seventh embodiment. In this embodiment, the included color that produces the most prominent difference in color appearance due to a difference in the visual characteristic of the user is determined. The patch display unit 2015 then generates the reference patch data, which are patch data representing the included color that produces the most prominent difference in color appearance, and the pre-verification patch data. A reference patch of the included color that produces the most prominent difference in color appearance is then displayed by performing similar processing to the seventh embodiment.

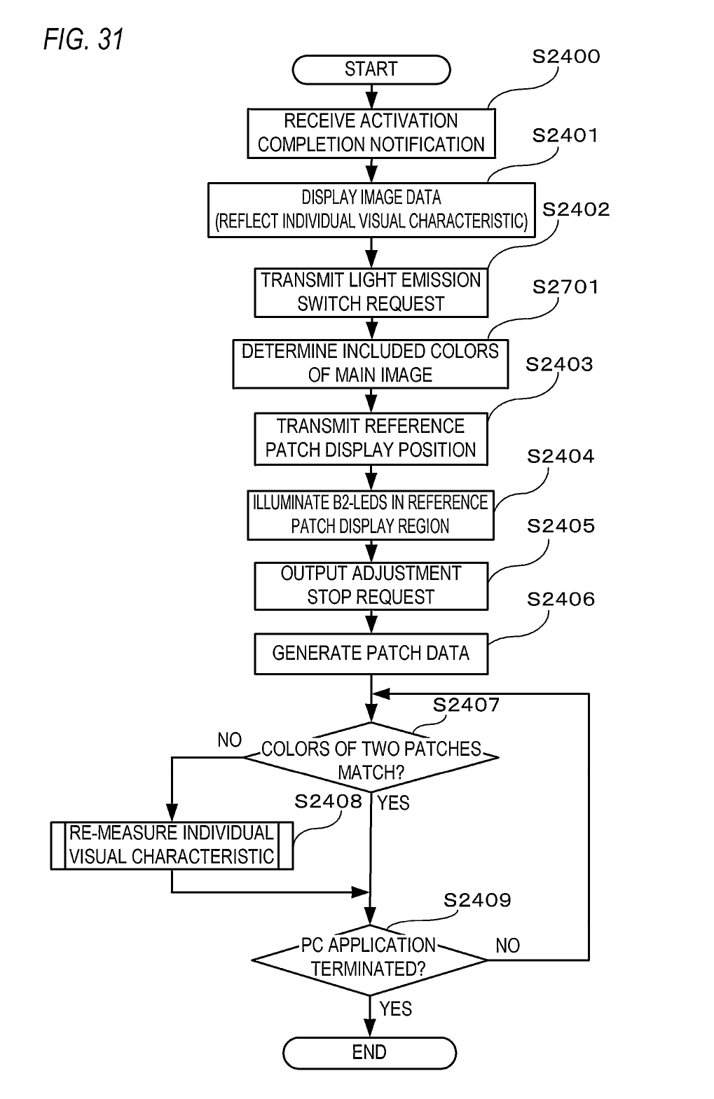

An example of a flow of processing performed in the system according to this embodiment will now be described using FIG. 31. FIG. 31 is a flowchart showing an example of a processing flow from display of the reference patch and the verification patch, with which the application condition of the individual visual characteristic can be checked, to re-measurement of the individual visual characteristic.

In FIG. 31, processing of S2701 is performed between the processing of S2402 and S2403 in FIG. 27. The processing of S2400 to S2409 in FIG. 31 is identical to the processing of S2400 to S2409 in FIG. 27, and therefore description thereof has been omitted.

In S2701, the image analysis unit 2810 analyzes the main image to determine which of the included colors included in the main image produces the most prominent difference in color appearance due to a difference in the visual characteristic of the user.

For example, the image analysis unit 2810 determines the included colors of the main image, and calculates an individually variant prominence for each determined included color. The individually variant prominence is a degree of prominence by which the appearance of a color differs due to a difference in the visual characteristic of the user. In this embodiment, information indicating an individually variant effect is prepared in advance for each color. The individually variant effect is a degree by which the appearance of a color differs due to a difference in the visual characteristic of the user. For each determined included color, the image analysis unit 2810 calculates a value obtained by multiplying an area ratio of the included color by the individually variant effect of the included color as the individually variant prominence of the included color. The area ratio is a ratio of a size of a region (a partial region of the main image) of the included color to a size of the region of the main image. Next, the image analysis unit 2810 selects the included color having the highest individually variant prominence as the included color that produces the most prominent difference in color appearance due to a difference in the visual characteristic of the user.

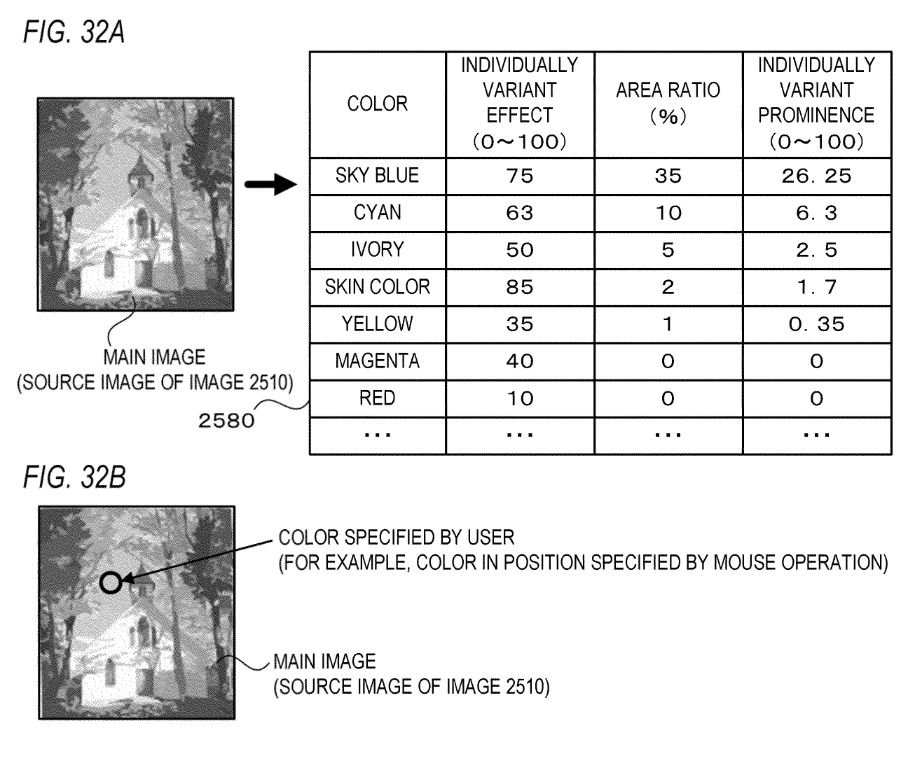

FIG. 32A shows examples of colors and the individually variant effect, area ratio, and individually variant prominence thereof. FIG. 32A shows an example of a case in which a source image of the main display image 2510 shown in FIGS. 28A, 28B and 28D serves as the main image. A reference numeral 2580 denotes a table of colors and the individually variant effect, area ratio, and individually variant prominence thereof.

In the example of FIG. 32A, sky blue has the highest individually variant prominence of 26.25 (individual effect 75×area ratio 35), and therefore sky blue is selected as the included color that produces the most prominent difference in color appearance due to a difference in the visual characteristic of the user. As a result, a sky blue patch is displayed as the reference patch.

As described above, in this embodiment, similarly to the seventh embodiment, the reference image and the verification image are displayed in the normal use mode. Further, at this time, an image in an included color of the main image is displayed as the reference image. In so doing, the user can be made aware of the high likelihood of a recognition error with respect to the main display image, and as a result, the individual visual characteristic can be re-measured at an appropriate timing. More specifically, the individual visual characteristic can be re-measured at a timing where the likelihood of a recognition error by the user with respect to the main display image is high.

Further, in this embodiment, an image of the included color that produces the most prominent difference in color appearance due to a difference in the visual characteristic of the user, from among the plurality of colors included in the main image, is displayed as the reference image. In so doing, the user can be made aware of the high likelihood of a recognition error with respect to the main display image at a more accurate timing, and as a result, the individual visual characteristic can be re-measured at an even more appropriate timing.

Note that in this embodiment, an example in which the included color that produces the most prominent difference in color appearance due to a difference in the visual characteristic of the user is determined by image analysis was described, but the present invention is not limited thereto. As shown in FIG. 32B, for example, an included color specified by the user may be selected from the plurality of colors included in the main image. An image of the included color specified by the user may then be displayed as the reference image. In so doing, the user can be made aware of the high likelihood of a recognition error with respect to the main display image at a more accurate timing. For example, the user can select an included color in a prominent location, and therefore the user can be made aware of the high likelihood of a recognition error with respect to the main display image at a more accurate timing. As a result, the individual visual characteristic can be re-measured at an even more appropriate timing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-226982, filed on Oct. 31, 2013, and Japanese Patent Application No. 2014-000189, filed on Jan. 6, 2014, which are hereby incorporated by reference herein in their entirety.

What is claimed is:

1. A display apparatus comprising:
a light-emitting unit; and
a displaying unit configured to display an image on a screen by modulating light from the light-emitting unit,
wherein, during a measurement mode, when a first image and a second image used to measure a visual characteristic of a user are displayed on the screen, the light-emitting unit is configured to emit a first light in a display region that includes a region in which the first image is displayed, and to emit a second light having a broader emission spectrum distribution than the first light in a display region that includes a region in which the second image is displayed.

2. The display apparatus according to claim 1, wherein during a normal image display mode, the light-emitting unit is configured to emit the first light over an entire area of the screen.

3. The display apparatus according to claim 1, wherein the light-emitting unit is configured to be capable of emitting the first light and the second light individually in a partial region of the screen, and
the displaying unit is configured to display the second image in the partial region where the first light and the second light can be emitted individually.

4. The display apparatus according to claim 1, wherein the light-emitting unit is configured to be capable of emitting the first light and the second light individually over an entire area of the screen.

5. The display apparatus according to claim 1, further comprising:
a display-controlling unit configured to perform control for displaying the first image and the second image on the screen; and
an obtaining unit configured to obtain a perception result by the user in relation to the first image and the second image displayed on the screen.

6. The display apparatus according to claim 3, further comprising a light-emission-controlling unit for controlling emitting the first light and the second light by the light-emitting unit.

7. The display apparatus according to claim 1, wherein the light emitting unit includes a first light source and a second light source and is configured
to emit the first light by driving the first light source, and
to emit the second light by driving the second light source.

8. The display apparatus according to claim 1, wherein the light-emitting unit includes a first light source and a second light source and is configured
to emit the first light by driving the first light source, and
to emit the second light by driving both the first light source and the second light source.

9. The display apparatus according to claim 7, wherein the first light source comprises a plurality of colored LEDs that emit differently-colored light, and
the second light source comprises a cold cathode tube element that emits white light.

10. The display apparatus according to claim 7, wherein the first light source comprises a plurality of colored LEDs that emit differently-colored light, and
the second light source comprises white LEDs that emit white light.

11. The display apparatus according to claim 8, wherein the first light source comprises a plurality of colored LEDs that emit differently-colored light, and
the second light source comprises colored LEDs that emit light of a different wavelength from a wavelength of the light emitted by the colored LEDs of the first light source.

12. The display apparatus according to claim 9, wherein the plurality of colored LEDs provided in the first light source include red LEDs, green LEDs, and blue LEDs.

13. The display apparatus according to claim 11, wherein the plurality of colored LEDs provided in the first light source include red LEDs, green LEDs, and blue LEDs, and
the colored LEDs provided in the second light source include:
colored LEDs that emit light of a wavelength between a wavelength of light emitted by the red LEDs and a wavelength of light emitted by the green LEDs; and
colored LEDs that emit light of a wavelength between a wavelength of the light emitted by the green LEDs and a wavelength of light emitted by the blue LEDs.

14. The display apparatus according to claim 11, wherein the plurality of colored LEDs provided in the first light source include red LEDs, green LEDs, and first blue LEDs, and
the colored LEDs provided in the second light source include second blue LEDs that emit light of a different wavelength from a wavelength of light emitted by the first blue LEDs.

15. The display apparatus according to claim 1, wherein during a normal image display mode, the displaying unit is configured to display a reference image that has not been subjected to image quality adjustment processing based on a measured visual characteristic, and a verification image obtained by applying the image quality adjustment processing to the reference image, and
when the reference image and the verification image are displayed on the screen, the light-emitting unit is configured to emit the first light in a display region that includes a region in which the verification image is displayed, and to emit the second light in a display region that includes a region in which the reference image is displayed.

16. The display apparatus according to claim 15, wherein during normal image display, the displaying unit is configured to display the reference image, the verification image, and a main display image obtained by applying the image quality adjustment processing to a main image, and
the reference image is an image of an included color, which is a color included in the main image.

17. The display apparatus according to claim 16, wherein the reference image is an image of an included color, from among a plurality of included colors of the main image, that produces a most prominent difference in color appearance due to a difference in the visual characteristic of the user.

18. The display apparatus according to claim 17, wherein the included color that produces the most prominent difference in color appearance due to a difference in the visual characteristic of the user is an included color in which a value is largest that is obtained by multiplying a ratio of a size of a region of the included color to a size of a region of the main image by a degree of difference in an appearance of the included color due to a difference in the visual characteristic of the user.

19. The display apparatus according to claim 16, wherein the reference image is an image of an included color specified by the user from a plurality of included colors of the main image.

20. A control method for a display apparatus having a light-emitting unit and a displaying unit configured to display an image on a screen by modulating light from the light emitting unit, the control method comprising:
performing control for displaying a first image and a second image used to measure a visual characteristic of a user on the screen; and
controlling light emission by the light emitting unit such that when the first image and the second image are displayed on the screen, first light is emitted in a display region that includes a region in which the first image is displayed, and second light having a broader emission spectrum distribution than the first light is emitted in a display region that includes a region in which the second image is displayed.
